(19) United States
(12) Patent Application Publication
(10) Pub. No.: US 2014/0302480 A1
(43) Pub. Date: Oct. 9, 2014

(54) COMPOSITE TISSUE GRAFT AND MATERIALS AND METHODS FOR ITS PRODUCTION AND USE

(71) Applicant: THE GENERAL HOSPITAL CORPORATION, Boston, MA (US)

(72) Inventor: Harald C. Ott, Wenham, MA (US)

(73) Assignee: THE GENERAL HOSPITAL CORPORATION, Boston, MA (US)

(21) Appl. No.: 14/356,631

(22) PCT Filed: Nov. 9, 2012
(86) PCT No.: PCT/US12/64437

§ 371 Date: May 7, 2014

Related U.S. Application Data
(60) Provisional application No. 61/557,475, filed on Nov. 9, 2011.

(51) Int. Cl. A01N 1/02

(52) U.S. Cl. CPC A01N 1/0205
USPC 435/1.1

(57) ABSTRACT

The technology described herein is directed to tissue engineering, e.g. to biomimetic compositions as well as methods and devices related to producing a biomimetic composition.

### CROSS-REFERENCE TO RELATED APPLICATIONS

This application claims benefit under 35 U.S.C. §119(e) of U.S. Provisional Application No. 61/557,475 filed Nov. 9, 2011, the contents of which are incorporated herein by reference in their entirety.

### TECHNICAL FIELD

The technology described herein relates to tissue engineering.

### BACKGROUND

Reconstruction of large tissue defects such as amputated limb and deformities after burns, combat injury, mechanic and ballistic trauma, tumors, as well as congenital deformities has been a challenge for current medical practice. The impact of such injuries on patients' lives is substantial and extends from simple loss of function (e.g. motor and sensory function such as ability to walk/grasp after limb amputation, ability to speak and swallow after facial injury, ability to breathe after chest wall injury/resection), to psychological consequences and social isolation due to overt cosmetic defects (e.g. loss of facial expression, mutilated facial aspect, loss of both hands.

Conventional approaches to restore function to these patients have included (a) prosthetic replacement of lost limb (e.g. arm prosthesis, leg prosthesis) (Huang et al. Acquired limb deficiencies. Prosthetic components, prescriptions, and indications. Arch Phys Med Rehabil. 2001 March; 82 (3 Suppl 1):S17-24), (b) autotransplantation of free tissue grafts (e.g. toe to thumb, fibula to mandible transplantation) (Woo et al. Immediate partial great toe transfer for the reconstruction of composite defects of the distal thumb. Plast Reconstr Surg. 2006 May; 117(6):1906-15)(Peled M, El-Naaj I A, Lipin Y, Ardekian L. The use of free fibular flap for functional mandibular reconstruction. J Oral Maxillofac Surg. 2005 February; 63(2):220-4), (c) allotransplantation of free tissue grafts (e.g. hand transplantation, face transplantation) (Dubernard et al. Human hand allograft: report on first 6 months. Lancet. 1999 Apr. 17; 353(9161):1315-20) (Devauchelle et al. First human face allograft: early report. Lancet. 2006 Jul. 15; 368(9531):203-9).

Current options offer only sub-optimal functional restoration and cosmetic results, and are related to substantial risks and side effects. In the case of autotransplantation (tissue transfer from a donor site in the same patient), the donor region may be functionally affected by the necessary tissue removal (Classen D A, Ward H. Complications in a consecutive series of 250 free flap operations. Ann Plast Surg. 2006 May; 56(5):557-61). In the case of allotransplantation (tissue transfer from a living or cadaveric donor to the patient), the need for long term immunosuppression causes organ damage and increased risk of development of cancer, while rejection may ultimately destroy the allograft and necessitate surgical removal (Schuind et al. Hand transplantation: The state-of-the-art. J Hand Surg [Br]. 2006 Nov. 7).

Currently available decellularized matrixes are either relatively thin such as heart valve prostheses (U.S. Pat. No. 4,388,735 Ionescu Marian I and coworkers), skin collagen (U.S. Pat. No. 5,336,616), intestinal submucosa (U.S. Pat. No. 5,372,821), or lost their original shape by fluidization or particulation (fluidized intestinal submucosa U.S. Pat. No. 5,275,826, particulated alloderm U.S. Pat. No. 6,933,326). These constructs lack characteristic shape, mechanical and physical properties and structure of the region to be replaced. These constructs also lack an intact vascular architecture that allows for effective recellularization and graft survival in vivo. Isolated solid organ matrixes offer intact vascular architecture, however, they do not exhibit matrix characteristics of composite tissues that allow for effective generation of a composite tissue graft.

### SUMMARY

The technology described herein is directed to tissue engineering, e.g. to biomimetic compositions as well as methods and devices related to producing a biomimetic composition.

In one aspect, the technology described herein relates to a biomimetic composition comprising: a) a decellularized composite tissue scaffold from a first individual; b) viable grafted cells from a second individual; wherein said cells are attached to said scaffold; wherein said cells are arranged in said composition in a manner including one or more of: correct axis of cellular orientation within the composition; functional interface with at least one other structure in the composition; and three dimensional arrangement on said scaffold that corresponds to the arrangement of cells of said composite tissue prior to decellularization.

In some embodiments, the composition can comprise at least two tissue structures comprising the grafted cells. In some embodiments, the composition can comprise at least two tissue types comprising the grafted cells. In some embodiments, the grafted cells can be comprised by a tissue of a type selected from the group consisting of: muscle tissue; nervous tissue; bone tissue; cartilaginous tissue; dermal tissue; adipose tissue; lymphatic tissue; connective tissue; ligaments; tendons; and endothelial tissue. In some embodiments, the composition can comprise cells of at least two cell types. In some embodiments, the grafted cells can comprise cells selected from the group consisting of: myocytes; myoblasts; osteocytes; osteoblast; chondrocytes; chondroblasts; fibrocytes; fibroblasts; adipocytes; dermal cells; endothelial cells; and nerve cells.

In some embodiments, the functional interface with at least one other structure can comprise a functional interface with at least one other tissue structure. In some embodiments, the functional interface with at least one other structure in the composition can comprise a physical connection. In some embodiments, the functional interface with at least one other structure in the composition can comprise an electrical connection. In some embodiments, the grafted cells can comprise a stem cell or the progeny thereof. In some embodiments, the stem cell can be selected from the group consisting of: mesenchymal stem cell; adult stem cell; iPS cell; progenitor cell; and embryonic stem cell. In some embodiments, the decellularized composite tissue scaffold can be from a biological source xenogenic to the grafted cells. In some embodiments, the decellularized composite tissue scaffold can be derived from a limb or a portion thereof.

In some embodiments, the decellularized scaffold can be created by a method comprising: perfusing the composite tissue with a cellular disruption solution; and perfusing the composition tissue with a rinsing solution. In some embodiments, the biomimetic composition can be maintained by a method comprising: perfusing the biomimetic composition with a growth or differentiation medium. In some embodiments, maintaining the biomimetic composition can further comprise stimulating the biomimetic composition mechanically or electrically. In some embodiments, the composition can further comprise an implant selected from the group consisting of: nerve graft; a vascular graft; a dermal graft; a bone graft; a bone substitute material; a dermal substitute graft; a joint substitute graft; a ligament graft; a tendon graft; a cartilage graft; and a muscle graft.

In some embodiments, the composition can be connected to a device which provides nutrients, electrical stimulation, or mechanical stimulation. In some embodiments, the composition can be connected to a device as described herein.

In one aspect, the technology described herein relates to a method of making a biomimetic composition, the method comprising: a) contacting a decellularized composite tissue obtained from a first individual with viable cells from a second individual; and b) maintaining the decellularized composite tissue and viable cells under conditions suitable for the growth and attachment of the cells.

In some embodiments, the viable cells or their progeny can comprise at least two cell types. In some embodiments, the viable cells or their progeny can comprise cells selected from the group consisting of: myocytes; myoblasts; osteocytes; osteoblast; chondrocytes; chondroblasts; fibrocytes; fibroblasts; adipocytes; dermal cells; endothelial cells; and nerve cells.

In some embodiments, after step b), the viable cells or their progeny can be arranged in the composition in a manner including one or more of: correct axis of cellular orientation within the composition; functional interface with at least one other structure in the composition; and three dimensional arrangement on said scaffold that corresponds to the arrangement of cells of said composite tissue prior to decellularization. In some embodiments, after step b), the viable cells or their progeny can form at least two tissue structures. In some embodiments, after step b), the viable cells or their progeny can form at least two tissue types comprising the grafted cells. In some embodiments, the tissue can be selected from the group consisting of: muscle tissue; nervous tissue; bone tissue; cartilaginous tissue; dermal tissue; adipose tissue; lymphatic tissue; connective tissue; ligaments; tendons; and endothelial tissue.

In some embodiments, the functional interface with at least one other structure can comprise a functional interface with at least one other tissue structure. In some embodiments, the functional interface with at least one other structure in the composition can comprise a physical connection. In some embodiments, the functional interface with at least one other structure in the composition can comprise an electrical connection. In some embodiments, the viable cells can comprise a stem cell or the progeny thereof. In some embodiments, the stem cell can be selected from the group consisting of: mesenchymal stem cell; adult stem cell; iPS cell; progenitor cell; and embryonic stem cell.

In some embodiments, the decellularized composite tissue can be from a biological source xenogenic to the viable cells. In some embodiments, the decellularized composite tissue scaffold can be derived from a limb or a portion thereof. In some embodiments, the biomimetic composition can be maintained by a method comprising: perfusing the biomimetic composition with a growth or differentiation medium. In some embodiments, maintaining the biomimetic composition can further comprise stimulating the biomimetic composition mechanically or electrically. In some embodiments, the method can further comprise introducing into the biomimetic composition an implant selected from the group consisting of: nerve graft; a vascular graft; a dermal graft; a bone graft; a bone substitute material; a dermal substitute graft; a joint substitute graft; a ligament graft; a tendon graft; a cartilage graft; and a muscle graft. In some embodiments, the composition can be connected to a device which provides nutrients, electrical stimulation, or mechanical stimulation. In some embodiments, the composition can be connected to a device as described herein.

In one aspect, the technology described herein relates to a tissue generator system for generating cell growth within a tissue scaffold, the system comprising: a bioreactor chamber having at least one inflow tube adapted to be connected to an artery of the tissue scaffold and at least one outflow flow tube adapted to be connected to a vein of the tissue scaffold; an inflow pump connected to the inflow tube and adapted to pump perfusion media into the bioreactor chamber through the inflow tube; at least one further outflow tube extending into the bioreactor chamber and providing outflow of perfusion media from the bioreactor chamber; and a gas exchanger connected to the pump and adapted to replenish the media flowing through the gas exchanger. In some embodiments, the system can further comprise a tissue mount for supporting the tissue scaffold and an actuator, coupled to the tissue mount, adapted to provide mechanical stimulation to the tissue scaffold. In some embodiments the actuator can include a pneumatic or hydraulic actuator connected to a pneumatic or hydraulic pump whereby the actuator imparts a motion to the tissue mount. In some embodiments, the motion imparted by the actuator can be at least one of rotation and translation. In some embodiments, the actuator can include an electric motor connected to an electric power source whereby the actuator imparts a motion to the tissue mount. In some embodiments, the system can further comprise at least two electrodes extending into the bioreactor chamber and adapted to apply an electrical stimulation signal to the tissue scaffold. In some embodiments, the electrical stimulation signal includes a square wave having pulse width ranging from 10 ms to 200 ms and voltage ranging from 30 to 50 volts. In some embodiments, the system can further comprise a controller connected to the inflow pump and an inflow pressure sensor coupled to the inflow tube for measuring pressure of the perfusion media flowing through the inflow tube, wherein the controller controls the inflow pump as a function of the measured pressure. In some embodiments, the bioreactor chamber can further include a filter permitting gas flow into and out of the bioreactor chamber and providing neutral pressure inside of the bioreactor chamber. In some embodiments, the system can further comprise an outflow pump connected to the further outflow tube, the outflow pump being adapted to draw perfusion media from within the bioreactor chamber and create a negative pressure within the bioreactor chamber.

In some embodiments, the system can further comprise a outflow pressure sensor coupled to the further outflow tube and wherein the controller is connected to the outflow pump and the outflow pressure sensor and controls the inflow pump and the outflow pump to maintain a negative pressure within the bioreactor chamber. In some embodiments, the system can further comprise a outflow pressure sensor coupled to the further outflow tube and wherein the controller is connected to the outflow pump and the outflow pressure sensor and controls the inflow pump and the outflow pump to maintain a positive pressure within the bioreactor chamber. In some embodiments, the system can further comprise a outflow pressure sensor coupled to the further outflow tube and wherein the controller is connected to the outflow pump and the outflow pressure sensor and controls the inflow pump and the outflow pump to change a pressure within the bioreactor chamber over time according to a predefined pressure protocol.

In some embodiments, the system can further comprise a cell injector connected to the inflow tube and adapted for delivering a cell suspension into the inflow tube. In some embodiments, the system can further comprise a cell injector connected to one or more needles, each needle including at least a portion extending into a tissue scaffold within the bioreactor chamber.

In some embodiments, the bioreactor chamber can be contained within a heating chamber and the heating chamber operates to maintain the bioreactor chamber at a substantially constant temperature. In some embodiments, the bioreactor chamber can be maintained between 36 and 38 degrees centigrade. In some embodiments, the system can further comprise a heating element connected to the inflow tube and adapted to apply heat to perfusion media flowing through the inflow tube. In some embodiments, the system can further comprise at least one supply reservoir containing perfusion media connected to the inflow tube whereby the inflow pump can pump perfusion media from the supply reservoir into the reactor chamber. In some embodiments, the system can further comprise at least one receiving reservoir connected to the outflow tube whereby perfusion media flowing through the outflow tube can be deposited into the receiving reservoir.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 is a schematic overview view of a decellularization apparatus.

FIG. 2 is a schematic view of a tissue generator.

FIG. 3 is a schematic view of a recellularized composite tissue graft.

FIG. 4 is a schematic view of a tissue transilluminator.

FIG. 5 depicts a schematic of the scaffold generation process described in Example 2.

FIG. 6 depicts a graph of the quantification of DNA content in a cadaveric limb and a cadaveric limb after the scaffold generation process shown in FIG. 5.

FIG. 7 depicts a graph of the quantification of sulfated glycosaminoglycans (sGAG) content in a cadaveric limb and a cadaveric limb after the scaffold generation process shown in FIG. 5.

FIG. 8 depicts images of H&E staining in a cadaveric limb and a cadaveric limb after the scaffold generation process shown in FIG. 5.

FIG. 9 depicts images of microtomography of a native composite tissue (left panel) and a decellularized composite tissue scaffold (right panel).

FIGS. 10A-10F depict the creation of an embodiment of a biomimetic composition as described herein. FIG. 10A depicts a cadaveric forearm and an H&E stained cross section. FIG. 10B depicts a decellularized scaffold derived from a cadaveric forearm and an H&E stained cross-section. FIG. 10C depicts a decellularized forearm scaffold at day 0 (left) and day 14 (right) after reseeding. FIG. 10D depicts immunohistochemical staining of native muscle (detection of alpha-skeletal myosin in left panel, detection of alpha actinin in right panel). FIG. 10E depicts immunohistochemical staining of a decellularized forearm scaffold (detection of alpha-skeletal myosin in left panel, detection of alpha actinin in right panel). FIG. 10F depicts immunohistochemical staining of muscle tissue in an embodiment of a biomimetic composition as described herein (detection of both alpha-skeletal myosin and nuclei). Positive staining appears as a darker color in FIGS. 10D-10F.

FIG. 11 depicts a schematic diagram of the generation of a decellularized forearm scaffold and a biomimetic composition as described herein.

FIG. 12 depicts the results, both graphically and photographically, of a test of Extensor Carpi Radialis function in a biomimetic composition as described herein.

FIG. 13 depicts a photograph of a forearm biomimetic composition orthotopically transplanted to a recipient. Blood flow in the biomimetic composition is visible.

FIG. 14 is a schematic view of a tissue bioreactor system according to an alternative embodiment of the invention;

FIG. 15 is a schematic view of a tissue bioreactor system according to another embodiment of the invention;

### DETAILED DESCRIPTION

As described herein, the inventors have discovered that decellularizing a composite tissue (e.g. a combination of tissues and non-cellular biological structures such as the extracellular matrix) obtained from a first individual provides a decellularized composite tissue scaffold that can be recellularized with grafted cells obtained from a second individual. While the decellularization process removes the cells of the composite tissue, the non-cellular material (e.g. the extra-cellular matrix) retains its native architecture and morphologic, mechanical, and physical characteristics. When the decellularized composite tissue scaffold is ‘reseeded’ with the grafted cells, the cells can attach to the scaffold and will grow and/or develop in such a way as to create tissues that mimic the native tissues. For example, the cells can 1) exhibit the correct axis of cellular orientation within the composition; 2) have a functional interface with at least one other structure in the composition; and/or 3) have a three dimensional arrangement on or within the scaffold that corresponds to the arrangement of the native composite tissue prior to decellularization. In various embodiments, the cells of a recellularized composite tissue can have one, two or all three of these characteristics, or any combination thereof.

Because the biomimetic compositions described herein exhibit structural characteristics of the native tissues which originally existed in the decellularized composite tissue scaffold, the biomimetic compositions can further exhibit the functionality of the native tissues. For example, as described in the Examples herein, a forearm biomimetic composition can comprise muscle tissues which permit wrist extension in response to pressure exerted on a tendon.

Accordingly, embodiments of the technology described herein relate to biomimetic compositions as well as methods and devices relating to the production and use of biomimetic compositions.

As used herein, a “biomimetic composition” refers to a composition comprising a) a decellularized composite tissue scaffold and b) viable grafted cells wherein said cells, or their progeny, are attached to said scaffold; and wherein said grafted cells, or their progeny, are arranged in said composition in a manner including one or more of: correct axis of cellular orientation within the composition; functional interface with at least one other structure in the composition; and three dimensional arrangement on said scaffold that corresponds to the arrangement of cells of said composite tissue prior to decellularization.

As used herein, the term “decellularized composite tissue scaffold” refers to the composition comprised of non-cellular (and optionally, non-viable cellular) biological material that remains when a composite tissue has been decellularized. As used herein, the term “decellularization” refers to the removal and/or extraction of cells and/or cellular components from a biological tissue while retaining the non-cellular components of the tissue. In some embodiments, a tissue or composite tissue is decellularized if at least 90% of the native cells have been removed, e.g. at least 90% of the native cells, at least 92% of the native cells, at least 95% of the native cells, at least 98% of the native cells, at least 99% of the native cells or more of the native cells have been removed. Methods of decellularization are discussed elsewhere herein. In some embodiments, a decellularized composite tissue scaffold can comprise, e.g. extracellular matrix, non-cellular connective tissue, collagen, and glycosaminoglycans. In some embodiments, a decellularized composite tissue scaffold can substantially retain the native architecture and/or morphology, e.g. examination (e.g. visual or microscopic) of the decellularized composite tissue scaffold can demonstrate voids in the scaffold that substantially retain the shape, orientation, and dimensions of the native tissues. As used in the foregoing paragraph, “substantially retain” refers to a difference of no more than 30% between the dimensions and/or orientation of a native tissue structure and the corresponding void present in the decellularized composite tissue scaffold.

As used herein, a “composite tissue” refers to a group of two or more different tissue structures and non-cellular material, e.g. extracellular matrix. In some embodiments, a composite tissue can comprise multiple tissue types. A composite tissue can comprise an organ, or an anatomical structure. Examples of composite tissues include, but are not limited to musculocutaneous tissue, fasciocutaneous tissue, osteocutaneous tissue, osteomyocutaneous tissue, neuromuscular tissue, neurocutaneous tissue, neuromyocutanous tissue, osteoneuromyocutanous tissue, an upper extremity (e.g. limb), a lower extremity (e.g. limb), a digit and portions or subsets thereof. In some embodiments, a composite tissue is a human composite tissue. In some embodiments, a composite tissue is a non-human composite tissue, e.g. rodent, sheep, rabbit, porcine, canine, bovine or equine composite tissue. In some embodiments, a composite tissue can be cadaveric.

As used herein a “tissue” refers to an aggregation of similarly specialized cells which together perform at least one particular function. As used herein, a “tissue structure” refers to a single physical tissue, e.g. a single muscle or a single bone. A tissue structure can be an isolated tissue structure or comprised by a larger biological structure, e.g. by an organ or composite tissue. As used herein, a “tissue type” refers to a class of tissues comprised by specific cell types that perform a particular function, e.g. muscles, bones, and nerves are exemplary and non-limiting tissue types. Further examples of tissue types include, but are not limited to muscle tissue; nervous tissue; bone tissue; cartilaginous tissue; dermal tissue; adipose tissue; lymphatic tissue; connective tissue; ligaments; tendons; and endothelial tissue.

As described herein, a biomimetic composition comprises both a decellularized composite tissue scaffold and viable grafted cells. As used herein, a “grafted cell” refers to a cell which is not native to the composite tissue, but which is, or has been, introduced to the decellularized composite tissue scaffold, or the progeny of such a cell. That is, a grafted cell is heterologous to the decellularized composite tissue scaffold. In some embodiments, the composite tissue can be obtained from a first individual and the grafted cells obtained from a second individual. In some embodiments, the composite tissue and grafted cells can be obtained from individuals of the same species. In some embodiments, the composite tissue and grafted cells can be obtained from individuals of different species. A decellularized composite tissue scaffold can be ‘reseeded’ or recellularized with cells as described elsewhere herein.

In some embodiments, a grafted cell can be terminally differentiated. In some embodiments, a grafted cell can be a stem or progenitor cell. A grafted cell can be, by way of non-limiting example, myocytes; myoblasts; osteocytes; osteoblast; chondrocytes; chondroblasts; fibrocytes; fibroblasts; adipocytes; dermal cells; endothelial cells; and nerve cells. In some embodiments, a biomimetic composition can comprise grafted cells of at least two cell types.

In some embodiments, a biomimetic composition comprises at least two tissue structures comprising the grafted cells, e.g. 2 tissue structures, 3 tissue structures, 4 tissue structures, 5 tissue structures, or more tissue structures. In some embodiments, a biomimetic composition comprises at least two tissue types comprising the grafted cells, e.g. 2 tissue types, 3 tissue types, 4 tissue types, 5 tissue types, or more tissue types. In some embodiments, the tissue type can be selected from the group consisting of: muscle tissue; nervous tissue; bone tissue; cartilaginous tissue; dermal tissue; adipose tissue; lymphatic tissue; connective tissue; ligaments; tendons; and endothelial tissue.

In some embodiments a cell which is introduced to the decellularized composite tissue scaffold can be terminally differentiated. In some embodiments a cell which is introduced to the decellularized composite tissue scaffold can be a stem or progenitor cell. Cells introduced to the decellularized composite tissue scaffold can be, by way of non-limiting example, myocytes; myoblasts; osteocytes; osteoblast; chondrocytes; chondroblasts; fibrocytes; fibroblasts; adipocytes; dermal cells; endothelial cells; nerve cells, embryonic stem cells (ESC), adult derived stem cells (ASC), bone marrow stem cells (BMC), skeletal myoblasts (SKMB), endothelial progenitor cells (EPC), mesenchymal stem cells (MSC), fibroblasts (FB), neural stem cells (NSC), cardiomyocytes, neurocytes, pericytes, epithelial cells, keratinocytes, melanocytes and/or fibrocytes. In some embodiments, the number of cells introduced to the decellularized composite tissue scaffold is at least about 1,000. In some embodiments, the number of cells introduced to the decellularized composite tissue scaffold is at least about 1,000 cells/g tissue (wet weight) to at least about 100,000,000/g tissue (wet weight) or more.

In some embodiments, the decellularized composite tissue scaffold can be from a biological source xenogenic to the grafted cells.

In some embodiments, the grafted cells comprised by a biomimetic composition are attached to the decellularized composite tissue scaffold. As used herein, a cell “attached” to a scaffold is a cell which bound to a scaffold (e.g. the extracellular matrix of a decellularized composite tissue scaffold) by the binding of adhesion polypeptides, e.g. selectins, integrins, and cadherins, to ligands present on and/or in the scaffold. A cell can be attached to the scaffold by a direct attachment or via an indirect attachment (e.g. a first cell is attached to the scaffold and a second cell is attached to the first cell).

In some embodiments, the grafted cells comprised by a biomimetic composition are arranged in the composition in a manner including one or more of: correct axis of cellular orientation within the composition; functional interface with at least one other structure in the composition; and three dimensional arrangement on said scaffold that corresponds to the arrangement of cells of said composite tissue prior to decellularization. These structural arrangements permit the cells and/or tissues of the biomimetic composition to perform one or more functions of the native tissues of the composite tissue. For example, a biomimetic composition comprising a scaffold obtained from a finger, hand and/or forearm can perform one or more of the following functions; contract and relax, to move individual fingers, to allow finger opposition, and/or to conduct sensory and/or motor nerve stimulation. As a further example, a biomimetic composition comprising a scaffold obtained from a foot and/or lower leg can perform one or more of the following functions; contract and relax, to allow weight bearing and gait. In some embodiments, a function can be cosmetic (e.g. the biomimetic composition can give the appearance of a native tissue); motor (e.g. the biomimetic composition can accomplish one or more movements performed by the relevant native tissue); and/or sensory (e.g. the biomimetic composition can perceive and/or transmit one or more sensory input signals perceived and/or transmitted by the relevant native tissue).

Cells are recognized as having an axis of orientation (e.g. a myocyte exhibits a long axis along which it expands and contracts). In some cases, the axis of orientation is further characterized by polarity (e.g. a neuron has poles characterized by either dendrites or axon terminals at the synapse; an epithelial cell has poles characterized by either an apical membrane or a basolateral membrane). As used herein “an axis of orientation” refers to an axis of a three-dimensional object which can be differentiated from other potential axes of the object, e.g. an axis of orientation of a muscle cell can be the axis which comprises the greatest possible dimension (e.g. diameter and/or length) of the cell and/or which is perpendicular to the cross-striations. Such structural axes of orientation are often coexistent with a functional characteristic, e.g. a myocyte contracts and expands along the axis of orientation which is structurally defined by the greatest possible dimension of the cell. In some embodiments, a cell can have an axis of orientation. In some embodiments, a tissue can have an axis of orientation. In some embodiments, a composite tissue can have an axis of orientation. A cell has the correct axis of cellular orientation within the composition when the axis of orientation for the particular cell type is discernable and is correctly oriented within the biomimetic composition, e.g. when the axis of orientation of a myocyte comprised by a muscle tissue (e.g. the axis defined by the greatest possible diameter of the myocyte) is substantially parallel with the axis along which the muscle tissue contracts and expands (i.e. the axis of orientation of the muscle tissue). “Correct” orientation is also established or defined relative to the orientation of a similar cell in a corresponding, naturally-occurring (i.e. non-recellularized) tissue.

In addition to having the correct axis of orientation within the biomimetic composition, cells comprised by the biomimetic composition can have a three dimensional arrangement on said scaffold that corresponds to the arrangement of cells of said composite tissue prior to decellularization. By correspondence, it is meant that collectively the cells of the biomimetic composition occupy locations and volumes similar to those occupied by cells of the same type that were native to the composite tissue, e.g. the locations and volumes do not differ by more than 30%, e.g. by 30% or less, 25% or less, 20% or less, 10% or less, or 5% or less. In some embodiments, the volume of a particular cell type in the biomimetic composition does not differ by more than 30% from the volume of that particular cell type in the native tissue of the scaffold, e.g. the volume of the particular cell type in the biomimetic composition is from about 70% to about 130% of that of the same cell type in the native tissue of the scaffold. In some embodiments, the locations of a particular cell type in the biomimetic composition do not differ by more than 30% from the locations of that particular cell type in the native tissue of the scaffold if no more than 30% of the cells of a particular cell type in the biomimetic composition are found in tissues or compartments which did not comprise that cell type in the native tissue. In some embodiments, the particular cell type can be all cells of that type in the biomimetic composition. In some embodiments, the particular cell type can be all cells of that type comprised by a tissue structure of the biomimetic composition.

In a composite tissue, each tissue is functionally connected with other structures in the composite tissue, e.g. with another tissue and/or with a non-cellular structure of the composite tissue. A connection which permits the native function of a tissue occurs at a functional interface. As used herein, a “functional interface” is a physical connection and/or attachment of a tissue with a composite tissue structure (e.g. a tissue or non-cellular structure) which permits the tissue to perform at least one native function. Mere physical contact and/or proximity are not sufficient. By way of non-limiting example, in order for a muscle to respond to a nerve signal and contract in order to move part of composite tissue, there must be a functional interface between the muscle and the nerve and between the muscle and the part of the composite tissue which is to be moved. Similarly, for a skeletal muscle contraction to move part of a composite tissue, the muscle generally has to be anchored on both ends (e.g. via functional interfaces) to different structures, such that muscle contraction moves one structure relative to the other.

In some embodiments, the functional interface with at least one other structure can comprise a functional interface with the decellularized composite tissue scaffold. In some embodiments, the functional interface with at least one other structure can comprise a functional interface with at least one other tissue structure. In some embodiments, the functional interface with at least one other structure in the composition comprises a physical connection. In some embodiments, the functional interface with at least one other structure in the composition can comprise an electrical connection.

Types of functional interfaces, their structural characteristics, and their functions are well known in the art. By way of non-limiting example, a neuromuscular junction can be characterized by presynaptic boutons which extend from the demyelinated motor axon to the membrane of the muscle cell, which forms invaginations at the junction and comprises acetylcholine receptors (known at the motor end-plate). Vesicles comprising acetylcholine are found within the presynaptic boutons and acetylcholine is released by exocytosis when the neuron is activated. Non-limiting examples of functional interfaces include anchoring junctions, neuromuscular junctions, occluding junctions, communicating junctions, focal adhesions, hemidesmosomes, myotendinous junction, osteotendinous junctions, and osteoligamentous junctions. In some embodiments, functional interfaces can include neuromuscular junctions, anchoring junctions, focal adhesions, hemidesmosomes, adherens junctions, desmosomes, myotendinous junction, osteotendinous junctions, and osteoligamentous junctions and are described in the art, e.g. in Molecular Biology of the Cell. 4th edition. Alberts B, Johnson A, Lewis J, et al. New York: Garland Science; 2002; which is incorporated by reference herein in its entirety.

In some embodiments, the biomimetic composition can comprise a joint with a functional set of functional interfaces comprising physical connections. A functional set of interfaces comprises two or more interfaces that are necessary to accomplish a biological function. By way of non-limiting example, for a biomimetic composition comprising a finger to achieve finger flexion or extension, multiple muscles must have physical functional interfaces with multiple bones. Some muscles must stabilize the proximal phalanx while a different set of muscles exert force on the distal and middle phalanx bones. In some embodiments, a functional set of interfaces can comprise the physical interfaces necessary to accomplish joint motion. In some embodiments, a functional set of interfaces can comprise the physical interfaces necessary to accomplish multi joint motion. In some embodiments, a functional set of interfaces can comprise the physical interfaces necessary to accomplish the normal motion of a saddle joint, a conyloid joint, a ball-and-socket joint, a gliding joint, a hinge joint, or a combination thereof. The functionality of a set of functional interfaces, e.g. a set of functional physical interfaces associated with a joint can be determined by physical (e.g. force applied via a tendon) or electrical stimulation (e.g. stimulation applied via a probe and/or a nerve).

Decellularization processes are known in the art, see, e.g. US Patent Publication 2009/0202977; which is incorporated by reference herein in its entirety. In some embodiments, decellularization can comprise contacting the composite tissue with detergents (cellular disruption solutions), e.g. SDS and/or Triton X-100 and following with a rinsing solution, e.g. PBS. In some embodiments, decellularization can comprise providing composite tissue, cannulating the composite tissue at one or more vessels to produce a cannulated composite tissue and perfusing the composite tissue with detergents and a rinsing solutions. In some embodiments, decellularization can comprise further perfusing a composite tissue with any of the following: thrombolytic solution (e.g. as described in US Patent Publication 2009/0202977), stabilizing and conserving solution (e.g. buffers and culture media), microbiocidal, fungicidal and virostatic solutions (e.g. solutions comprising antibiotics, fungicides, or virocidal agents), and/or buffer solutions (e.g. non-toxic buffers having a pH of about 7.3-7.5), e.g. either concurrently or sequentially with the detergents and washing solutions discussed above. Multiple intravascular catheters can be inserted to allow for selective perfusion of parts of the composite tissue. These catheters can be equipped with balloons to completely occlude the vessel into which they were inserted. Typically, the thrombolytic solution will contain one or more thrombolytic enzymes, the stabilizing and conserving solution will contain one or more protease inhibitors and buffers, the cellular disruption solution will contain free water, one or more ionic and non-ionic detergents, which can be alternated, and the buffer solution will contain at least one buffer system and the washing solution will reconstitute physiologic extracellular conditions, such as a pH of 7.3-7.5 and a sodium-chloride concentration of 0.9%. In some embodiments, different parts of the composite tissue can receive different exposure times of cellular disruption solution, buffer solution and washing solution. In some embodiments, these solutions can be delivered through multiple catheters, in multidirectional fashion, and/or at varying perfusion pressures.

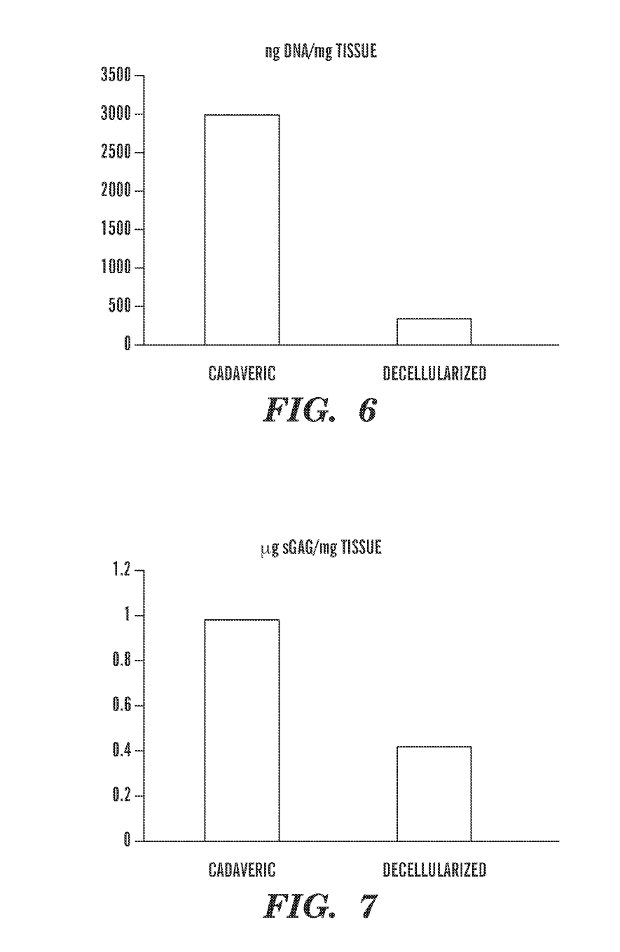

The length of decellularization, e.g. the amount of time the composite tissue is contacted with to cellular disruption solutions (e.g. detergents) is dependent upon the size of the tissue and the method of introducing the cellular disruption solution. By way of non-limiting example, the length of time a murine forearm composite tissue is perfused with cellular disruption solution can range from about 60 to about 100 hours. The composite tissue can be determined to have been contacted with the cellular disruption fluid for a sufficient length of time when the composite tissue is observed to have no areas of color and to have assumed a clear appearance (e.g. as shown in FIG. 5). Such a determination can be made by direct observation or with the use of a tissue transilluminator, which can be optionally automated.

In some embodiments, decellularization can further comprise identifying and labeling or marking a particular structure or structures for later reference, e.g. for forming connections during a transplantation of a biomimetic composition. In some embodiments, such a method can include perfusing the composite tissue with biocompatible dye to identify vascular architecture and the vessels required for anastomosis to provide sufficient tissue perfusion of the entire composition. These vessels can be labeled by colored sutures to permit easy identification on transplantation. For example, to make a decellularized myocutaneous composite tissue scaffold, a myocutaneous composite tissue is decellularized as described herein and the major arteries and veins are cannulated and labeled and/or the nerves are labeled. In some embodiments, making a decellularized composite tissue scaffold can entail removing parts of the decellularized composite tissue. For example, the tissue can be trimmed to the desired size, shape and composition. In some embodiments, all insufficiently perfused areas of the composite tissue can be removed, as these would not receive sufficient nutrient supply after connection to a patient's circulatory system. In some embodiments, acellular keratinized layers of skin matrix can be removed by mechanical abrasion.

A non-limiting example of a decellularization protocol for a forearm composite tissue is as follows: systemic heparinization (American Pharmaceutical Partners) through the intravenous catheter is followed by the dissection of the skin of the whole upper limb. The brachial artery, the brachial vein and the nerve plexus are identified. After dissecting the upper limb from the shoulder the brachial artery is cannulated with a prefilled 25G cannula (Luer Stubs, Harvard/Instech) using a surgical microscope. In some embodiments, fasciotomies are performed before flushing the forearm with phosphate buffered saline (PBS). After flushing, perfusion is started with 1% SDS (Sigma) for 65 h at a constant flow perfusion of 1 ml/min. This is followed by deionized water for 30 min and 1 h of perfusion with 1% Triton-X100 (Sigma). To wash out all debris, antibiotic-containing PBS (100 U/ml penicillin-G; Sigma, 0.25 mg/ml streptomycin; Sigma and amphotericin B; Sigma) is used to perfuse the forearm for 124 h.

In some embodiments, a fasciotomy can be performed during the decellularization process, i.e. prior to recellularization. In some embodiments, a fasciotomy can be performed before the introduction of a cellular disruption solution (e.g. SDS or Triton X-100) to the composite tissue. A fasciotomy removes and/or disrupts part or all of the outermost connective tissue layer of at least one tissue (e.g. muscle), e.g. the fascia or fascial envelope, to permit tissue expansion during the decellularization process. A fasciotomy can include stripping, perforating, excising, or other methods of compromising and/or disrupting the native structure of at least one fascia. In some embodiments a fasciotomy can comprise removing and/or disrupting part or all of at least one fascia, e.g. one fascia, two fascia, three fascia, or more fascia in the composite tissue. If the fascia is not removed, the intracompartmental pressure (e.g. the pressure inside the fascia) can increase as the tissue swells. If the intracompartmental pressure exceeds the perfusion pressure, perfusion can be decreased and/or interrupted. A fasciotomy can improve perfusion both during decellularization and recellularization, allowing faster and higher quality production of a decellularized composite tissue scaffold and/or a biomimetic composition. In some embodiments, the fascia or outermost-envelope of any tissue type can be removed and/or disrupted during the decellularization process, e.g. prior to the introduction of a cellular disruption solution.

A further non-limiting example of a decellularization protocol for a forearm composite tissue is as follows: the composite tissue is perfused with 1% SDS for 60 h, 1% Triton X-100 for 2 hours, and PBS for 124 hours.

Recellularization can be accomplished by any method of introducing cells known in the art. By way of non-limiting example, cells can be introduced to the decellularized composite tissue scaffold by injection, perfusion, perfusion via cannulated vessels, diffusion, coating, layering, and the like or combinations thereof.

In some embodiments, cells introduced to the decellularized composite tissue scaffold can be in solution, e.g. in a buffer or in media suitable for the culture of cells. In some embodiments, cells introduced to the decellularized composite tissue scaffold can be comprised by a biodegradable scaffold or hydrogel. In some embodiments, cells introduced to the decellularized composite tissue scaffold can be comprised by particles, e.g. biodegradable particles.

In some embodiments, cells introduced to the decellularized composite tissue scaffold can be of one cell type. In some embodiments, cells introduced to the decellularized composite tissue scaffold can be a clonal population. In some embodiments, cells introduced to the decellularized composite tissue scaffold can be obtained from one individual.

In some embodiments, cells introduced to the decellularized composite tissue scaffold can be of multiple cell types. In some embodiments, cells introduced to the decellularized composite tissue scaffold can be of multiple cell types, wherein a mixture comprising cells of multiple types are introduced to the scaffold. In some embodiments, cells introduced to the decellularized composite tissue scaffold can be of multiple cell types, wherein multiple compositions, each composition comprising one cell type, are introduced to the scaffold, e.g. at the same time or different times. In some embodiments, cells of different types can be introduced to different portions of the scaffold and/or introduced to the scaffold by different methods, e.g. muscle cells can be introduced to voids in the interior of the scaffold by injection while dermal cells are coated on the exterior surface of the scaffold.

A non-limiting example of recellularization of a murine forearm decellularized composite tissue scaffold is as follows: the scaffold is mounted in a biomimetic stimulation bioreactor system under sterile conditions (bioreactor systems are described in greater detail elsewhere herein). Prior to cell seeding, the decellularized composite tissue scaffold is perfused with 37° C. oxygenated C2C12 growth medium for 1 h at constant flow perfusion of 5 ml/min under standard culture conditions (37° C. in 5% CO2). The biomimetic stimulation bioreactor contains an organ chamber, which also serves as the main reservoir, in which the decellularized scaffold is mounted. The bioreactor works as a closed-circuit system in which medium is perfused into the brachial artery by a constant flow pump (Ismatec). For cell seeding a cell mixture of 40×10⁶ C2C12 cells and 10×10⁶ mouse embryonic fibroblasts suspended in 0.5 ml of growth medium was injected via twenty injections of 30 μl each into the compartments of the decellularized forearm with a 27-G needle and a 1-cc tuberculin syringe. After cell seeding the forearm was mounted in the biomimetic stimulation bioreactor and sterile stimulation electrodes (Warner Instruments) sutured to the wrist and to the elbow of the forearm scaffold. No electrical stimulation was applied in the first 5 days. Mechanical stimulation can be provided by attaching the forearm to an inflatable balloon (Harvard Apparatus) covered by a polyester mesh tube, which is connected to a small animal ventilator (Harvard Apparatus). Rate and extent of stretch can be adjusted via adjustment of the tidal volume and respiratory rate. The pressure tubing is connected to a differential pressure sensor (Harvard Apparatus), which is connected to a powerlab system, enabling triggering of electrical stimulation with mechanical stretch. The scaffold can be perfused with C2C12 growth media from day 0 to day 5. The medium is changed every 48 h. On day 5, the medium is switched to C2C12 differentiation medium. At day 6, electrical and mechanical stimulation is begun by applying 50-ms pulses of 20 V and 1 Hz with a Grass S48 square pulse stimulator (Grass Technologies). At day 9 the forearm decellularized composite tissue scaffold is seeded with 20×10⁶ HUVECs by direct infusion into the brachial artery suspended in 0.5 ml Endothelial Cell Growth media (EGM-2 Bulletkit; Lonza). After a 90-minute static period to allow for cell attachment, perfusion is restarted with a 50:50 mixture of C2C12 differentiation media and EGM-2 media. The biomimetic composition is maintained in culture for up to 11 days.

A non-limiting example of a recellularization protocol for a murine forearm decellularized composite tissue scaffold is as follows: inject the radius/ulna spaces with 5 million osteoblasts in 0.2 cc of media, and the muscle tissue spaces with 40 million myoblasts and 10 million undifferentiated MSCs in 0.5 cc of media. The scaffold can then be wrapped in a split thickness skin graft and is maintained for 4 days. On Day 5, the culture media is changed for differentiation media. On Day 6, electrical and mechanical stimulation as described elsewhere herein is begun. On Day 9, the media is changed to a 50/50 mixture of differentiation media and EGM2. On Day 9, the artery is seeded with 20 million HUVECs in 0.5 cc of media. The biomimetic composition is further cultured to Day 11.

Growth media for a particular cell type is a medium which permits proliferation of the cells. In contrast, differentiation media permits a lower rate of proliferation than growth media and permits the differentiation and/or maturation of a terminally differentiated phenotype. Differentiation media typically has a lower serum concentration than growth media and can further comprise cytokines and/or differentiation factors specific for the desired mature cell types. Examples of growth and differentiation media for various cell types are known in the art. By way of non-limiting example, formulations suitable for use as growth and differentiation media for myocytes include the following: growth media can comprise DMEM (Gibco) supplemented with 15% FBS, and 1% HyClone Antibiotic Antimycotic solution (Thermo Scientific). Differentiation media can comprise DMEM (Gibco) supplemented with 5% horse serum (Gibco) and 1% antibiotic antimycotic solution (10,000 units/ml penicillin, 10,000 μg/ml streptomycin, and 25 μg/ml Amphotericin B; HyClone).

A further non-limiting example of recellularization of a myocutaneous composite tissue includes injecting endothelial progenitor cells through a cannulated artery and vein, injecting skeletal myoblasts into the decellularized muscle matrix, and layering keratinocytes and skin fibroblasts onto the decellularized dermal matrix.

In some embodiments, the scaffold and/or biomimetic composition is maintained during, and/or after recellularization. As used herein “maintain” refers to continuing the viability of a tissue or population of cells. A maintained tissue will have a population of metabolically active cells. The number of these cells can be roughly stable over a period of at least one week or can grow. Maintaining a biomimetic composition can include providing nutrients, suitable temperatures, stimulation, and/or perfusion.

In some embodiments, solutions comprising nutrients and/or cells are provided via perfusion through one or more arterial structures. The pressure of these solutions as provided to the scaffold and/or biomimetic composition should not exceed physiological pressures. The relevant fluid pressures for a particular composite tissue from a particular biological source are known in the art and/or are readily determined by one of ordinary skill in the art. By way of non-limiting example, the fluid pressure supplied to a composite tissue scaffold comprising a murine forearm (or a biomimetic composition comprising such a scaffold) should not exceed 70 mmHg. In some embodiments, e.g. when endothelial cells are introduced to a decellularized composite tissue scaffold and/or biomimetic composition, the pressure of the fluid can be varied, e.g. after the introduction of the cells, fluid flow can be ceased and then slowly increased over time. By way of non-limiting example, when endothelial cells are perfused into a decellularized composite tissue scaffold derived from a murine forearm (or a biomimetic composition comprising the scaffold), perfusion can be stopped for 4 hours, then restarted at 10 mmHg, increasing gradually to 60 mmHg over a period of 12 hours.

In some embodiments, the fluid being perfused through a biomimetic composition can be under negative pressure. Methods and devices for permitting this are described elsewhere herein.

A non-limiting example of maintaining a decellularized composite tissue scaffold (e.g. one derived from a forearm) is as follows: after recellularization, the scaffold is perfused at 37° C. with a 50:50 mixture of C2C12 differentiation media and EGM-2 growth medium at constant flow perfusion of 5 ml/min under standard culture conditions (37° C. in 5% CO2). In some embodiments, the maintaining occurs in a bioreactor, e.g. a closed-circuit system in which medium is perfused into the brachial artery by a constant flow pump (Ismatec).

In some embodiments, a biomimetic composition can be maintained using a device and/or system as described elsewhere herein.

By way of non-limiting example a biomimetic composition can be maintained (e.g. in a tissue generator) that stimulates physiologic conditions, e.g. a temperature of 38° C., humidity of 60% and perfusion with cell growth media. In some embodiments, growth factors (e.g., FGF or TGF-beta) and/or serum can be added to the perfusion media.

Maintaining a biomimetic composition can last from about 12 hours to about 65 days. Maintaining a biomimetic composition can last until the tissues comprised therein have matured to the desired stage and/or until the composition is ready to be used (e.g. for transplant). In some embodiments, maintaining a biomimetic composition can comprise immersing the composition in a solution (e.g. growth and/or differentiation media). In some embodiments, maintaining a biomimetic composition does not comprise immersing the composition in a solution (e.g. growth and/or differentiation media); providing nutrient solution by perfusion only.

In some embodiments, maintaining a biomimetic composition can comprise altering the oxygen content of the tissue, e.g. by altering the oxygen content of the fluid being perfused through the tissue. The partial pressure of a given gas withing the media can be controlled, e.g. by a gas exchange system or oxygenator as described elsewhere herein. By way of non-limiting examples, normoxic conditions can be created by allowing the perfusion fluid to equilibrate with gas comprising about 5% CO₂, about 21% O₂, and about 74% N₂. In some embodiments, normoxic conditions can be created by perfusing fluid with the following gas partial pressures: pO₂=141 mmH, pCO₂=38 mmHg. In some embodiments, hypoxic conditions can be created by allowing the perfusion fluid to equilibrate with gas comprising about 5% CO₂, about 0.5-5% O₂, and about 90-94.5% N2. In some embodiments, hyperoxic conditions can be created by allowing the perfusion fluid to equilibrate with gas comprising as much as about 95% O2. Modulation of the oxygen content of the tissue can modulate growth and differentiation.

In some embodiments, maintaining the biomimetic composition can further comprise stimulating the biomimetic composition mechanically or electrically. In some embodiments, electrical stimulation can be achieved by attachment of electrodes to the biomimetic composition. In some embodiments, mechanical stimulation can be achieved by attachment of force transducers to parts of the biomimetic composition. In some embodiments, these force transducers can be attached to computer controlled servo motors. In some embodiments, mechanical stimulation can include stretching or flexing the biomimetic composition through at least 50% of the native range of motion for a corresponding composite tissue, e.g. for a rat forearm, the range of flexion in the wrist can be about 10 mm. Accordingly, mechanical stimulation can comprise causing the biomimetic composition comprising a forearm composite tissue scaffold to experience wrist flexion of about 5 mm to about 10 mm, e.g. about 6 mm to about 10 mm, about 7 mm to about 10 mm, about 8 mm to about 10 mm, or about 9 mm to about 10 mm. The range of motion of any given joint and/or tissue from a particular species is known in the art and/or are readily determined by one of ordinary skill in the art. By way of non-limiting example, the range of motion for one or more tissues and/or joints in an individual composite tissue can be determined prior to decellularization and used to determine the appropriate amount of mechanical stimulation for the biomimetic composition created from that individual composite tissue. In other embodiments, average ranges of motion for a given tissue and/or joint from a given biological source can be used.

In some embodiments, the electrical and mechanical stimulation can be coordinated, e.g. electrical stimulation can be applied to a muscle tissue in a biomimetic composition when the tissue is contracting or at its most contracted state, but not while it is extending or at its most extended state. Methods and devices relative to coordinating electrical and mechanical stimulation are described further elsewhere herein.

In some embodiments, the biomimetic composition described herein can be connected to a device and/or system which provides nutrients, electrical stimulation, and/or mechanical stimulation.

A non-limiting example of stimulation protocol is as follows: a recellularized composite tissue scaffold is mounted in a biomimetic stimulation bioreactor and sterile stimulation electrodes (Warner Instruments) sutured to the wrist and to the elbow of the forearm scaffold. No electrical stimulation is applied in the first 5 days. Mechanical stimulation can be provided by attaching the forearm to an inflatable balloon (Harvard Apparatus) covered by a polyester mesh tube, which is connected to a small animal ventilator (Harvard Apparatus). Rate and extent of stretch can be adjusted via adjustment of the tidal volume and respiratory rate. The pressure tubing is connected to a differential pressure sensor (Harvard Apparatus), which is connected to a powerlab system, enabling triggering of electrical stimulation with mechanical stretch. The scaffold can be perfused with C2C12 growth media from day 0 to day 5. The medium is changed every 48 h. On day 5, the medium is switched to C2C12 differentiation medium. At day 6 electrical and mechanical stimulation is begun by applying 50-ms pulses of 20 V and 1 Hz with a Grass S48 square pulse stimulator (Grass Technologies).

A further non-limiting example of an electrical stimulation protocol for a murine forearm biomimetic composition is as follows: the decellularized composite tissue scaffold was seeded with myoblasts and MEFs on Day 0. Media was changed from expansion media to differentiation media on Day 5. On Day 6 electrical stimulation, triggered by mechanical stimulation, was begun, via two electrodes attached to elbow and wrist, 10 mm apart. For the first 24 hours the conditions were: frequency 1 Hz, Voltage 0.1V, pulse duration 100 ms. From 24 to 48 hours of the electrical stimulation, the conditions were: frequency 1 Hz, Voltage 1V, pulse duration 100 ms. From 48 hours to 72 hours, the conditions were: frequency 1 Hz, Voltage 4V, pulse duration 100 ms. From 72 hours until the end of the experiment, the conditions were: frequency 1 Hz, Voltage 8V, pulse duration 100 ms. The physical setup was as follows: the recellularized scaffold was positioned in a chamber containing 37° C. medium and perfusion controlled by a digital controlling pump. (Materflex Incorp.). The recellularized scaffold was pinned down at the wrist with one minutien pin. The proximate end of a muscle was connected to the stiff metal wire. The wire was then mounted to a calibrated transducer. The transducer was fixed by micromanipulator (Newport Corporation). TRI202pad (Harvard Apparatus) was used to measure normal rat forearm muscles, and Aurora 403A (Aurora Scientific) to measure muscles in regenerated forearm. Two parallel platinum wire electrodes were attached to the forearm, with the muscle which is being measured in the middle of electrodes and a distance of 1 cm between electrodes. Contractions were observed using dissection microscope and camera at frame rate>30/s. Electrical stimulation signal was controlled by electrical stimulator. (Harvard Apparatus). The parameters were set as below: Voltage: 10-40 V; Frequency: 0.5-40 Hz; Pulses time: 1-2 ms; Total duration: 2 s.

In some embodiments, a biomimetic composition can comprise vasculature, muscle, bone, skin, nervous tissue, or combinations thereof.

In some embodiments, the biomimetic composition can further or additionally comprise an implant. An implant can comprise cellular or acellular material or a combination thereof. As opposed to recellularization with grafted cells, an implant comprises an acellular material or a biological tissue as opposed to the isolated cells introduced during recellularization. Non-limiting examples of implants can include nerve graft; a vascular graft; a dermal graft; a bone graft; a bone substitute material; a dermal substitute graft; a joint substitute graft; a ligament graft; a tendon graft; a cartilage graft; and a muscle graft. In some embodiments, a split thickness skin graft or a full thickness skin graft derived from a patient can be layered onto the recellularized composite tissue graft before, at the time of or after transplantation to a patient.

In some embodiments, a biomimetic composition as described herein can be for use in transplantation. In some embodiments, the cells introduced to the scaffold can be autologous to the transplant patient. In some embodiments, the cells introduced to the scaffold can be allogenic to the transplant patient. In some embodiments, the cells introduced to the scaffold can be xenogenic to the transplant patient. In some embodiments, the composite tissue used to generate the decellularized composite tissue scaffold can be autologous to the transplant patient. In some embodiments, the composite tissue used to generate the decellularized composite tissue scaffold can be allogenic to the transplant patient. In some embodiments, the composite tissue used to generate the decellularized composite tissue scaffold can be xenogenic to the transplant patient. In some embodiments, the composite tissue used to generate the decellularized composite tissue scaffold can be washed, sterilized, trimmed, preserved, and/or packaged prior to recellularization. In some embodiments, the decellularized composite tissue scaffold used to generate the biomimetic composition can be washed, sterilized, trimmed, preserved, and/or packaged prior to recellularization. In some embodiments, the biomimetic composition can be washed, trimmed, preserved, and/or packaged prior to recellularization.

In some embodiments, the biomimetic composition can be implanted into or connected to a recipient subject (e.g. patient in need of a transplant). In some embodiments, the implantation and/or connection can result in nervous innervation of the biomimetic composition (e.g. sensory and/or motor neuron innervation). In some embodiments, the implantation and/or connection can result in connection of the biomimetic composition to the nervous system of the of recipient. In some embodiments, the nervous connection results in innervation and/or function of the biomimetic composition in a manner corresponding to at least one function of a corresponding native composite tissue. In some embodiments, the implantation and/or connection can result in connection of the biomimetic composition to the vascular system of the of recipient. In some embodiments, the vasular connection results in perfusion and/or function of the biomimetic composition in a manner corresponding to at least one function of a corresponding native composite tissue. In some embodiments, a muscle tissue of a biomimetic composition can be connected (e.g. to the nervous and/or vascular system of the recipient) such that the muscle is perfused, innervated, and/or functions in a manner corresponding to at least one function of a corresponding native muscle.

In some embodiments, the biomimetic composition can comprise a grasping structure, e.g. a hand or an implant which can function as a grasping device. In some embodiments, the biomimetic composition can comprise a mobility aid/walking aid, e.g. a leg or portion thereof or an implant which can function as a mobility aid/walking aid.

In some embodiments, the biomimetic composition can be connected to a donor, e.g. a decellularized composite tissue scaffold can be connected to a donor of cells for recellularization.

In some embodiments, the biomimetic composition can comprise one or more vascular pedicles for permitting connection to the patient's circulatory system. In some embodiments, the biomimetic composition can comprise one or more neural pedicles for permitting connection to the patient's neural system. By way of non-limiting example, a biomimetic composition, e.g. an osteoneuromyocutaneous biomimetic composition such as a forearm/hand graft can be transplanted to a patient by connecting the corresponding tissues to each other in a surgical fashion. The patient's radial and ulnar arteries can be connected to the biomimetic composition's arteries, the patient's cephalic vein to the biomimetic composition's veins by vascular anastomoses with running sutures or cuff anastomoses. The patient's median, ulnar and radial nerve can be connected to the biomimetic composition's nerves by sutures. The patient's ulna and radius stump can be connected to the biomimetic composition's ulnar and radius stump by osteosynthesis. The patient's muscles and tendons can be connected to the biomimetic composition's muscles and tendons. In some embodiments, the biomimetic composition can then be covered by split skin grafts taken from the patient. In some embodiments, the biomimetic composition can comprise a partial bone structure for use in transplantation, e.g. a humerus stump.

In one aspect, provided herein is a method of making a biomimetic composition, the method comprising: a) contacting a decellularized composite tissue obtained from a first individual with viable cells from a second individual; and b) maintaining the decellularized composite tissue and viable cells under conditions suitable for the growth and attachment of the cells. Conditions and devices/systems suitable for the growth and attachment of the cells (e.g. suitable for maintaining a biomimetic composition) are described elsewhere herein. In some embodiments, maintaining the decellularized composite tissue and viable cells further comprises stimulating the decellularized composite tissue and viable cells mechanically or electrically.

In one embodiment, a decellularized composite tissue scaffold can comprise decellularized mammalian composite tissue for use in the methods described herein. In one embodiment, a decellularized composite tissue scaffold can comprise, without limitation, skin matrix, fat tissue matrix, fascia matrix, muscle matrix, arterial matrix, venous matrix, bone matrix, areolar connective tissue matrix, tendon matrix, ligament matrix, cartilage matrix, nerve matrix, bone marrow matrix and/or combinations thereof. In some embodiments, the decellularized arteries and veins of a decellularized composite tissue scaffold can be cannulated by one or more arterial cannula and one or more venous cannula. In some embodiments, the decellularized composite tissue scaffold (and biomimetic compositions comprising a decellularized composite tissue scaffold) can be transplanted without connection to the patient's vascular system or can be connected to the patient's vascular system by connecting the arterial matrix and the venous matrix to the patient's circulatory system. In some embodiments, the decellularized composite tissue can provide one or more vascular pedicle allowing for connection to the patients circulatory system. In some embodiments, the decellularized composite tissue can be washed, sterilized, trimmed, preserved and packaged prior to transplantation. In some embodiments, the decellularized composite tissue can provide one or more nerve matrixes allowing connection to the patient's neural system.

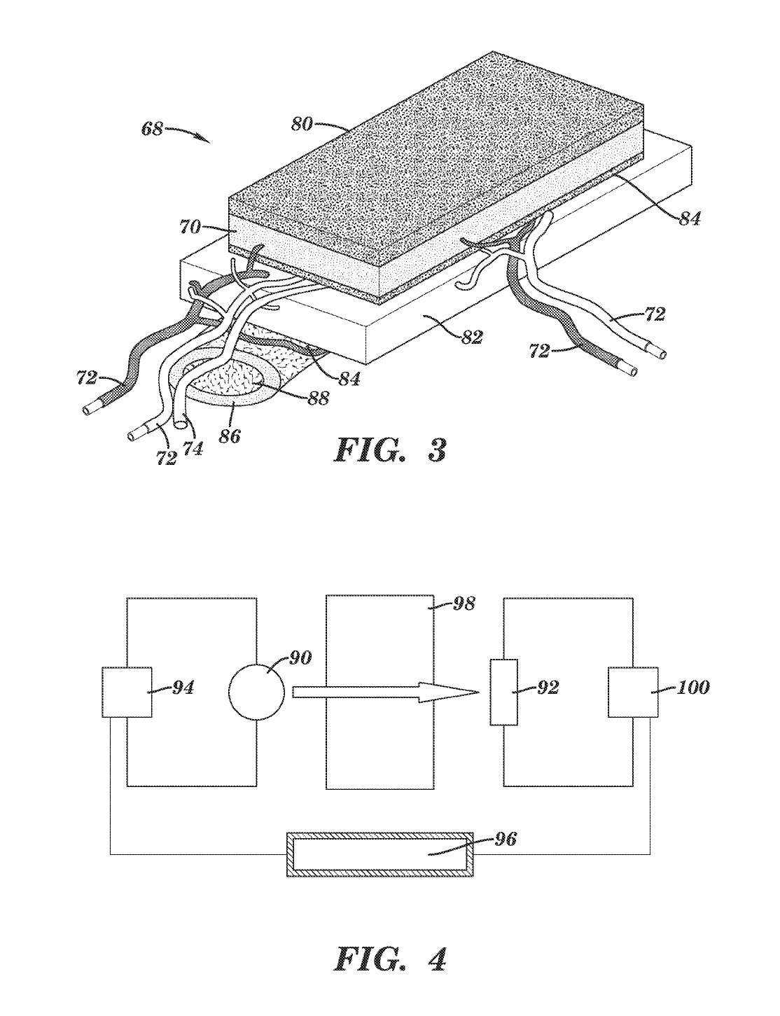

A schematic of one embodiment of a biomimetic composition is depicted in FIG. 3. A biomimetic composition 64 can comprise, e.g., muscle tissue 68, fat tissue 70, one or more blood vessels 72, one or more nerve tissues 74, skin tissue 80, fascial tissue 82, areolar connective tissue 84, bone tissue 86, bone marrow 88, and/or combinations thereof.

It is contemplated that the methods described herein can be permit the construction of various tissues, organs, and/or body parts, e.g. an appendage, a head, a torso, an abdominal wall, a joint, a hip, a spine, a finger, a hand, a forearm, an upper arm, a shoulder, an occiput, a mandible, a face, a chest wall, an upper leg, a lower leg, a foot, a toe, and portions or subsets thereof.

In some embodiments, the methods described herein relate to treating a subject having or diagnosed as in need of transplantation, e.g. subjects lacking a functional tissue and/or composite tissue (e.g. one or more organs or a portion thereof). In some embodiments, a subject in need of transplantation lacks a particular composite tissue, e.g. has had a limb amputated. In some embodiments, a subject in need of transplantation has a dysfunctional or nonfunctional composite tissue, e.g. a diseased and/or injured composite tissue. Disease and/or injury can include congenital defects or conditions, infectious conditions, chronic conditions, or trauma.

Pharmaceutically acceptable carriers and diluents include saline, aqueous buffer solutions, solvents and/or dispersion media. The use of such carriers and diluents is well known in the art.

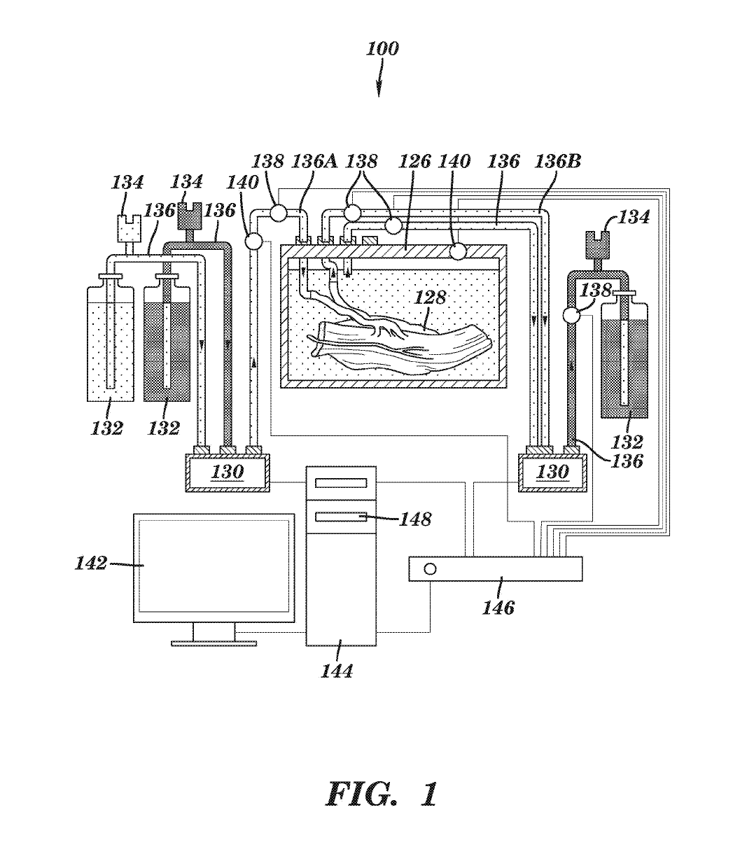

FIG. 1 shows a schematic view of a decellularization apparatus or system 100 according to one embodiment of the invention. The decellularization process according to the invention can be performed using a decellularization system such as decellularization system 100. The decellularization system 100 can include, a decellularization chamber 126, one or more fluid pumps 130, one or more fluid reservoirs 132, one or more bubble traps 134, tubing 136, one or more pressure sensors 138, one or more temperature sensors 140, and a control system, such as a computer 144 connected to the operative components to control at least some aspects of the decellularization process. In accordance with some embodiments of the invention the control system can include a computer 144 having one or more processors and one or more associated memories. The control system can also include a hardware interface 146 connected to computer 144 to provide an interface between the controlled devices (e.g., fluid pumps 130) and sensors (e.g. pressure sensors 138 and temperature sensors 140) the computer 144. In addition, the control system can also include a computer screen 142 for displaying information relating to the process, such as sensor reading and pump status (e.g. on/off and speed) to permit monitoring of the process and one or more data storage devices 148 for storing process data and documentation.

The computer 144 can also include, stored in one of the data storage devices 148, one or more computer programs for controlling the operation of the system during the decellularization process. In accordance with some embodiments of the invention, the programs can be used to implement one or more protocols which can cause one or more system parameters (e.g., pump motor speed, temperature or pressure) to change at various points in time or upon the sensing of an event (e.g., based on a sensor value) over the process. As one of ordinary skill will appreciate, the specific programs and protocols will vary depending on the tissue or organ being decellularized.

In accordance with some embodiments of the invention, the decellularization chamber 126 can be a sterile chamber with one or more ports that allow one or more tubes to be inserted into the decellularization chamber 126 to allow media to flow into and out of the chamber as well as to monitor and control the pressure and/or temperature within the decellularization chamber 126. The chamber 126 can include an opening and a mount (not shown) to allow tissue samples or organs to be inserted and supported within the chamber 126. In addition, the chamber 126 can include one or more ports to allow one or more tubes 136 to pass through the wall of the chamber 126. In some embodiments of the invention, the tubes 136 can transport decellularization media to the tissue sample or organ 128 as part of the decellularization process. The tissue sample or organ can include one or more arterial cannulas and one or more venous cannulas to enable decellularization media to enter and leave the tissue sample or organ 128. As shown in FIG. 1, the arterial cannula can be connected to the inflow tube 136A and the venous cannula can be connected to the outflow tube 136B.

In this embodiment of the invention, an inflow pump 130A draws fluid decellularization media from one or more source reservoirs 132A and pumps the decellularization media into the arterial cannula of the tissue sample or organ 128. The inflow tube 136A can include one or more pressure sensors 138 and one or more temperature sensors 140 to monitor the pressure and temperature of the fluid entering the chamber. Similarly, an outflow pump 130B draws decellularization media fluid from the venous cannula and pumps it into one or more receiving reservoirs 132B. In some embodiments of the invention, the decellularization media can perfuse through the tissue sample or organ 128 and collect inside the decellularization chamber 126. A second outflow tube 136 can be provided to drain the decellularization media fluid from the bottom of the decellularization chamber 126. In accordance with some embodiments of the invention, one or more of the tubes 136A, 136B, 136 can include a bubble trap 134 to prevent air bubbles from flowing into chamber 126.

In some embodiments of the invention, a sensor system can be provided to aid in determining when the decellularization process is completed. In some embodiments, an illumination system can be used to detect the level of decellularization based on transmitted or reflected electromagnetic radiation (e.g., visible light, infrared or ultraviolet radiation) of tissue sample or organ 128. In other embodiments, an electronic system can be used to detect the level of decellularization based on the electrical properties of the tissue sample or organ 128. In some embodiments, an illumination system can comprise an excitation light and a photosensor. In some embodiments, an excitation light and/or a photosensor can be inserted into a tissue of the scaffold and/or biomimetic composition or inserted into the vascular system of a scaffold and/or biomimetic composition. In some embodiments, a fluorescent dye (e.g. DAPI) can be perfused into the scaffold and/or biomimetic composition, e.g. to label and monitor DNA by detecting DAPI. Such a monitoring scheme can permit, e.g., quantitative measurement of the recellularization process.

In accordance with some embodiments of the invention, the decellularization system 100 can be used to perform the decellularization process. In accordance with some embodiments, a tissue sample or organ having an arterial cannula and venous cannula can be mounted inside the decellularization chamber 126 and connected to the inflow tube 136A and outflow tubes 136B and 136. Optionally, the chamber can be filled with decellularization media to partially or full submerge the tissue sample or organ 128. In accordance with some embodiments, the control system can execute one or more programs on computer 144 to initiate the flow of decellularization media into the tissue sample or organ 128. During this process the pumps 130 can be initialized and ramped up while at the same time the temperature and/or pressure from the temperature and pressure sensors can be monitored. After a predetermined time and/or based upon sensor readings, the process can be stopped and the decellularized tissue scaffold can be removed from the decellularization chamber 126.

It is another object of the invention to provide a tissue generation apparatus, herein referred to as a tissue generator or tissue bioreactor. A tissue generator as described herein can include a closed, sterile system into which a composite tissue can be mounted for decellularization, recellularization and tissue formation. In one embodiment, a tissue generator consists of a single, water jacketed tissue chamber, water jacketed tubing, one or more perfusion pumps, an oxygenator, one or more fluid reservoirs, one or more bubble traps, a compliance chamber, one or more pressure sensors, one or more temperature sensors, and a central data acquisition, recording and controlling system. The size and complexity of the tissue generator can vary depending on the complexity of the composite tissue graft.

It is another object of the invention to provide for a tissue diagnostic apparatus. A tissue diagnostic apparatus as described herein can include one or more light sources, a control unit, one or more photosensors and a user interface. In one embodiment, the user interface allows for choosing tissue type and thickness and contains a readout screen determining cellularity of the tested tissue. In some embodiments, the tissue diagnostic apparatus can be integrated into a tissue generator.

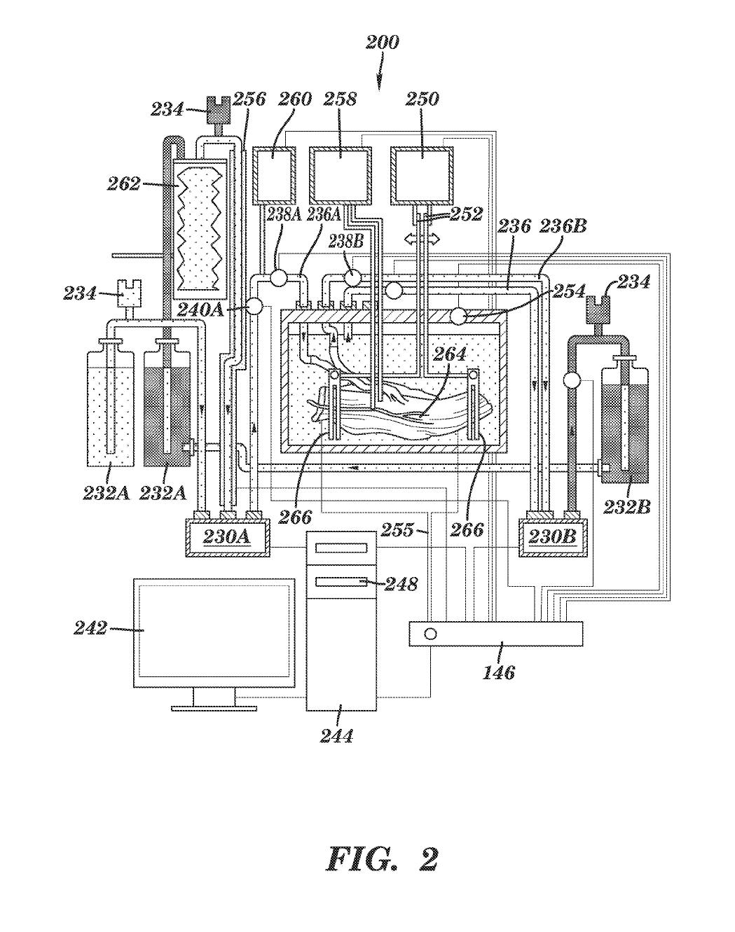

FIG. 2 shows a schematic view of a tissue generating bioreactor system 200 according to one embodiment of the invention. The recellularization or tissue generation process according to the invention can be performed using a tissue generating bioreactor system such as bioreactor system 200 to convert a tissue scaffold into a composite tissue graft 264. The bioreactor system 200 can include, a bioreactor chamber 254, one or more fluid pumps 230, one or more fluid reservoirs 232, one or more bubble traps 234, tubing 236 for transporting perfusion media, one or more pressure sensors 238, one or more temperature sensors 240, one or more pH sensors (not shown), one or more force generators 250, one or more line heaters 256, one or more electrical stimulation devices 258, one or more cell injectors 260, one or more oxygenators 262, a compliance chamber, and a control system, such as a computer 244 connected to the operative components to control at least some aspects of the recellularization process. In accordance with some embodiments of the invention the control system can include a computer 244 having one or more processors and one or more associated memories. The control system can also include a hardware interface 246 connected to computer 244 to provide an interface between the controlled devices (e.g., fluid pumps 230) and sensors (e.g. pressure sensors 238, temperature sensors 240, and pH sensors 252) and the computer 244. In addition, the control system can also include a computer screen 242 for displaying information relating to the process, such as sensor reading and pump status (e.g. on/off and speed) to permit monitoring of the process and one or more data storage devices 248 for storing process data and documentation.

The computer 244 can also include, stored in one of the data storage devices 248, one or more computer programs for controlling the operation of the system during the recellularization process. In accordance with some embodiments of the invention, the programs can be used to implement one or more protocols which can cause one or more system parameters (e.g., pump motor speed, temperature or pressure) to change at various points in time or upon the sensing of an event (e.g., based on a sensor value) over the process. As one of ordinary skill will appreciate, the specific programs and protocols will vary depending on the tissue or organ being regenerated and the nature of the desired recellularization process.

In accordance with some embodiments of the invention, the bioreactor chamber 254 can be a sterile chamber with one or more ports that allow one or more tubes to be inserted into the bioreactor chamber 254 to allow recellularization perfusion media to flow into and out of the chamber as well as to monitor and control the pressure and/or temperature within the bioreactor chamber 254. The chamber 254 can include an opening and a mount (e.g., one or more tissue connectors 266) to allow tissue samples or organs to be inserted and supported within the chamber 254. In addition, the chamber 254 can include one or more ports to allow one or more tubes 236 to pass through one or more walls of the chamber 254. In some embodiments of the invention, the tubes 236 can transport recellularization media to the tissue sample or organ 264 as part of the recellularization process. The tissue sample or organ scaffold 264 can include one or more cannulated arteries and one or more cannulated veins to enable recellularization media to enter and leave the tissue sample or organ 264. As shown in FIG. 2, the arterial cannulas can be connected to the inflow tube 236A and the venous cannulas can be connected to the outflow tube 236B.

In accordance with some embodiments of the invention, a cell injector 260 can be connected to one of the inflow tubes 236A to allow cells to be injected into one or more of the cannulated arteries during the recellularization process. The cell injector 260 can be connected to and controlled by computer 244 to deliver a known volume of cell suspension over a defined period of time (such as 1 million per 10 ul media for a total of 1 cc over 1 minute). The cell injector 260 can also be connected to one or more needles that can be inserted directly into the tissue and attached to the cell injector via tubing. The cell injector 260 can also draw from a suspension reservoir that can be periodically or continuously agitated to keep the cells in suspension (such as a magnetic stir plate).

In this embodiment of the invention, an inflow pump 230A draws recellularization media from one or more source reservoirs 232A and pumps the recellularization media into the arterial cannula of the tissue sample or organ 264. The inflow tube 236A can include one or more pressure sensors 238A and one or more temperature sensors 240A to monitor the pressure and temperature of the fluid entering the bioreactor chamber 254. Similarly, an outflow pump 230B draws recellularization media fluid from the venous cannula and pumps it into one or more receiving reservoirs 232B. In some embodiments of the invention, the recellularization media can perfuse through the tissue sample or organ 264 and collect inside the bioreactor chamber 254. A second outflow tube 236 can be provided to drain the recellularization media fluid from the bottom of the bioreactor chamber 254. In accordance with some embodiments of the invention, one or more of the tubes 236A, 236B, 236 can include a bubble trap 234 to prevent air bubbles from flowing into the bioreactor chamber 254.

In accordance with some embodiments of the invention, one or more receiving reservoirs 232B can be connected one or more source reservoirs 232A. And one or more of the source reservoirs 232A can be connected to a gas exchanger 262 such that recellularization perfusion media from the receiving reservoirs 232B can be replenished by passing it through the gas exchanger 262 prior to pumping it into the bioreactor chamber 254. In accordance with some embodiments of the invention, the gas exchanger can include a gas exchange membrane to permit gas diffuse into and out of the perfusion media. In accordance with other embodiments of the invention, the gas exchanger can include gas permeable silicone tubing to permit gas diffuse into and out of the recellularization perfusion media.

In some embodiments of the invention, a sensor system can be provided to aid in determining when the recellularization process is completed. In some embodiments, an illumination system can be used to detect the level of recellularization based on transmitted or reflected electromagnetic radiation (e.g., visible light, infrared or ultraviolet radiation) of tissue sample or organ 264. In other embodiments, an electronic system 255 can be used to detect the level of recellularization based on the electrical properties of the tissue sample or organ 264. For example, electric signals similar to EKG signals or electric field potential signals can be measured and used to determine a level of development of the recellularization of the tissue sample or organ 264.

The size and complexity of the tissue generating bioreactor system 200 can vary depending on the complexity of the composite tissue graft 264 to be produced. The basic function of the tissue generating bioreactor system 200 is to provide physiologic environment (e.g. temperature of 35 to 37.5 degree Celsius, humidity of 50-70%, pH of 7.2-7.6) and sufficient tissue perfusion (0.1-100 ml/g tissue depending on tissue type) to allow cell engraftment, differentiation and tissue maturation. Cells can be delivered through an injector 260 into the vascular system or through direct injection into the composite tissue graft 264. The tissue generating bioreactor system 200 can include one or more force generators 250, connected to the tissue through one or more force transducers 252 and tissue connectors 266. The tissue connectors 266 can be connected or coupled to the tissue 264 to provide mechanical stimulation to the growing tissue and the embedded cells. The tissue generating bioreactor system 200 can include an electrical stimulator 258, providing electrical stimulation to the growing tissue. Electrical stimulation can be provided by applying 2 or more electrodes to various points on the tissue sample or organ 264. Tubing 236 can be heated with a line heater 256 to minimize temperature variations.

In accordance with some aspects of the invention, the mechanical stimulation 250 can be provided by providing an actuator outside the bioreactor chamber 254 and providing a shaft through one of the walls such that rotation or translation of the shaft causes at least one of the tissue connectors 266 to move. Preferably, the motion should mimic the physiologic range of motion of the tissue sample or organ being generated. In some embodiments, the motion can be in the range from 1 to 10 mm, for example, 2 mm, 3 mm, 4 mm, 5 mm, 6 mm, 7 mm, 8 mm, 9 mm. In addition, more than one moving tissue connector 266 can be provided depending on the tissue sample or organ 264 (e.g., one for each finger of a hand or degree of motion of a joint). Preferably, the frequency of the motion is in the range from 0.1 Hz to 5.0 Hz and this parameter may vary as a function of the type of tissue and nature of the organ.

In accordance with some aspects of the invention, the electrical stimulation 258 can be coordinated with the mechanical stimulation to optimize tissue generation or avoid tissue damage. For example, the electrical stimulation causing the cells to contract can be coordinated to correspond to the mode where the mechanical stimulation is causing the tissue sample or organ 264 to contract or is about to complete a contraction portion of the mechanical cycle. In order to avoid potential damage to the tissue, electrical stimulation causing contraction should be avoided when mechanical stimulation is moving to produce expansion. In some embodiments of the invention, the electrical signal can include a 10-200 ms pulse square wave signal in the 0.25 to 3.0 Hz frequency range and 25-55 volt range.

In accordance with some embodiments of the invention, the recellularization system 200 can be used to perform the recellularization process according to the invention. In accordance with some embodiments, a tissue sample or organ matrix or scaffold having at least one cannulated artery and at least one cannulated vein can be mounted inside the bioreactor chamber 254 and connected to the inflow tube 236A and outflow tubes 236B and 236. Optionally, the chamber can be filled with cell growth media to partially or full submerge the tissue sample or organ scaffold 264. In accordance with some embodiments, the control system can execute one or more programs on computer 244 to initiate the flow of cell growth media into the tissue sample or organ scaffold 264. During this process the pumps 230 can be initialized and ramped up while at the same time the temperature and/or pressure from the temperature and pressure sensors can be monitored. In accordance with some embodiments of the invention, the temperature can be maintained between 36 and 38 degrees C. and the pressure can be maintained between 40 mm and 70 mm of Hg. In accordance with some embodiments of the invention, the perfusion pressure can ramp up from less than 10 mm of Hg to as high as 70 mm of Hg over a predefined time period, for example, 12 hours. After a predetermined time and/or based upon sensor readings, the process can be stopped and the recellularized tissue sample or organ 264 can be removed from the bioreactor chamber 254.

In accordance with some embodiments of the invention, the tissue generating bioreactor system 200 can operate using a pressure controlled perfusion mode in which the pressure of the inflowing recellularization media is maintained at a predefined pressure or follows a predefined pressure profile by reading pressure sensors and modulating the inflow pump 230A to achieve the desired pressure. This embodiment is in contrast to other embodiments where the inflow is controlled based on a desired volumetric flow rate of perfusion. In the pressure controlled perfusion mode, the system can be figured to provide a minimum predefined pressure or maximum (not to exceed) predefined pressure. The speed of the inflow pump 230A can be controlled as function of the inflow pressure measured by pressure sensor 238A.

In accordance with some embodiments of the invention, the reaction chamber 254 can be maintained at either a neutral pressure, a positive pressure or a negative pressure. The pressure inside the reaction chamber 254 can be measured by a pressure sensor mounted inside the chamber or an external pressure sensor attached to a port on the chamber wall. The pressure inside the reaction chamber 254 can be modified by changing the relative pressures of the flow through the inflow tube 236A and the flow through one or more outflow tubes 236 and/or 236B. In accordance with some embodiments, the pressure inside the reaction chamber can change over time and be changed by the control system according to a predefined pressure profile which identifies specific pressures or pressure ranges over the course of time.

In accordance with some embodiments of the invention, the reaction chamber 254 can be maintained at a constant temperature or according to a predefined temperature profile that varies over time. In these embodiments, one or more temperature sensors 240B inside the reaction chamber 254 or connected through a port on the wall of the reaction chamber 254 can be used to monitor the temperature. In addition, temperature sensor 240A mounted to inflow tube 236A can be used to measure the temperature of the perfusion media entering the reaction chamber 254 and line heater 256 can be used to raise or lower the temperature of the perfusion media entering the reaction chamber 254 to control the temperature of the tissue sample or organ 264 in the chamber.

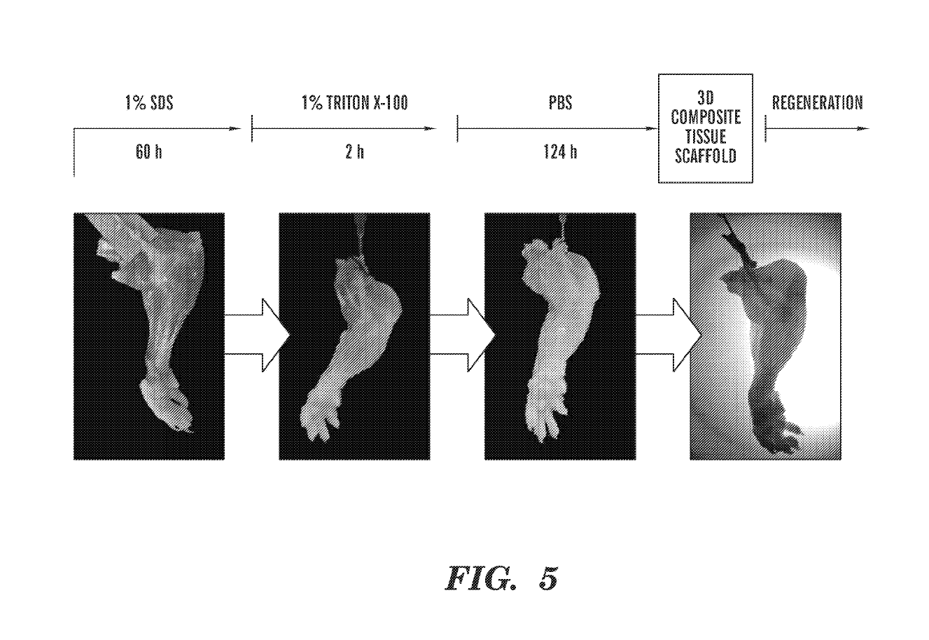

FIG. 4 shows a schematic view of a tissue transilluminator 116 according to one embodiment of the invention. The tissue transilluminator 116 that allows measurement of tissue cellularity by transillumination. The tissue transilluminator can include a light source 90 that emits different wavelengths of light and a photosensor 92 that measures the light that passes through the tissue. An interface 100 can be provided to accept input information, such as the tissue type and tissue thickness and built in software can be provided to calculate tissue cellularity as a function of the photosensor data and one or more of the input information. The tissue cellularity information can be displayed on a display screen. The tissue transilluminator 116 can a communication port to allow the tissue transilluminator 116 to be connected to a computer 44 of the tissue generator system 200. In some embodiments, the tissue cellularity information can be transferred to the computer 44 to provide for continuous monitoring. In other embodiments, the computer 44 can communicated with the tissue transilluminator 116 to control its operation (e.g., input tissue type and/or thickness) as well as provide for continuous monitoring.

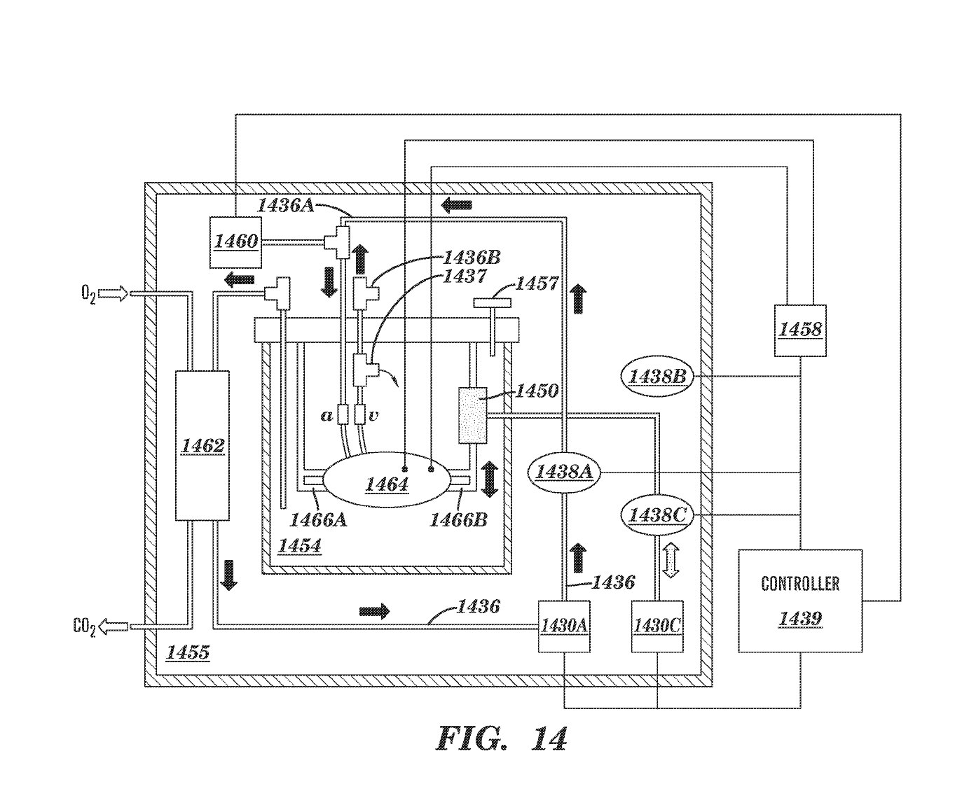

FIG. 14 shows a schematic view of a tissue generating bioreactor system 1400 according to an alternative embodiment of the invention. The recellularization or tissue generation process according to the invention can be performed using a tissue generating bioreactor system such as bioreactor system 1400 to convert a tissue scaffold into a composite tissue graft 1464. The bioreactor system 1400 can include, a bioreactor chamber 1454, a heating chamber 1455, one or more fluid pumps 1430, tubing 1436 for transporting perfusion media, one or more pressure sensors 1438, one or more temperature sensors (not shown), one or more pH sensors (not shown), one or more force generators 1450, one or more electrical stimulation devices 1458, one or more cell injectors 1460, one or more gas exchangers 1462, and a control system 1439, such as a computer 244 connected to the operative components to control at least some aspects of the recellularization process. In accordance with some embodiments of the invention the control system can include a computer 244 having one or more processors and one or more associated memories. The control system can also include a hardware interface 246 connected to computer 244 to provide an interface between the controlled devices (e.g., fluid pumps 1430) and sensors (e.g. pressure sensors 1438, temperature sensors, and pH sensors) and the computer 244. In addition, the control system can also include a computer screen 242 for displaying information relating to the process, such as sensor reading and pump status (e.g. on/off and speed) to permit monitoring of the process and one or more data storage devices 248 for storing process data and documentation.

In accordance with some embodiments of the invention, the bioreactor chamber 1454 can be a sterile chamber with one or more ports that allow one or more tubes to be inserted into the bioreactor chamber 1454 to allow recellularization perfusion media to flow into and out of the chamber as well as to monitor and control the pressure and/or temperature within the bioreactor chamber 1454. The chamber 1454 can include an opening and a mount (e.g., one or more tissue connectors 1466) to allow tissue samples or organs to be inserted and supported within the chamber 1454. In addition, the chamber 1454 can include one or more ports to allow one or more tubes 1436 to pass through one or more walls of the chamber 1454. In some embodiments of the invention, the tubes 1436 can transport recellularization media to the tissue sample or organ 1464 as part of the recellularization process. The tissue sample or organ scaffold 1464 can include one or more cannulated arteries (“a”) and one or more cannulated veins (“v”) to enable recellularization media to enter and leave the tissue sample or organ 1464. As shown in FIG. 14, the arterial cannulas can be connected to the inflow tube 1436A and the venous cannulas can be connected to the outflow tube 1436B.

In accordance with some embodiments of the invention, a cell injector 1460 can be connected to one of the inflow tubes 1436A to allow cells to be injected into one or more of the cannulated arteries during the recellularization process. The cell injector 1460 can be connected to and controlled by computer 1444 to deliver a known volume of cell suspension over a defined period of time (such as 1 million per 10 ul media for a total of 1 cc over 1 minute). The cell injector 1460 can also be connected to one or more needles that can be inserted directly into the tissue and attached to the cell injector via tubing. The cell injector 1460 can also draw from a suspension reservoir that can be periodically or continuously agitated to keep the cells in suspension (such as a magnetic stir plate).

In this embodiment of the invention, an inflow pump 1430A draws fluid recellularization media from the bottom of chamber 1454 through gas exchanger 1462 and pumps the recellularization media through the inflow tube 1436A into the arterial cannula (“a”) of the tissue sample or organ 1464. The gas exchanger 1462 can allow the recellularization media to be replenished, for example, by allowing oxygen to be absorbed into the recellularization media and carbon dioxide to be released from the recellularization media. The inflow tube 1436A can include one or more pressure sensors 1438A (and optionally, one or more temperature sensors, not shown) to monitor the pressure (and temperature) of the fluid entering the bioreactor chamber 1454. In some embodiments of the invention, the recellularization media can perfuse through the tissue sample or organ 1464 and collect inside the bioreactor chamber 1454. The outflow tube 1436B can be connected to the venous cannula (“v”) to direct the flow of recellularization media out of the chamber 1454. The outflow tube 1436B can include a valve 1437 that allows some or all of the recellularization media flowing from the venous cannula (“v”) to flow back into the chamber 1454. When the valve 1437 is closed, the recellularization media flows into the bottom of the heating chamber 1455. In operation, the valve 1437 can be adjusted between open and closed to control the amount recellularization fluid that flows into the heating chamber 1455. Optionally, a supply reservoir 1455 (not shown) inside the heating chamber can be connected to the inflow tube 1436A to allow the supply of recellularization fluid to be replenished.

In some embodiments, the gas exchanger can include a dialysis membrane. In some embodiments, the dialysis membrance can permit the flow of media and the counterflow of washing solution, e.g to permit clearance of toxins and replenishment of nutrients and growth factors without the requirement that the entire system be emptied of media.

In accordance with some embodiments of the invention, a sensor system can be provided to aid in determining when the recellularization process is completed. In some embodiments, an illumination system can be used to detect the level of recellularization based on transmitted or reflected electromagnetic radiation (e.g., visible light, infrared or ultraviolet radiation) of tissue sample or organ 1464. In other embodiments, an electronic system can be used to detect the level of decellularization based on the electrical properties of the tissue sample or organ 1464. For example, electric signals similar to EKG signals or electric field potential signals can be measured and used to determine a level of development of the recellularization of the tissue sample or organ 1464.

The size and complexity of the tissue generating bioreactor system 1400 can vary depending on the complexity of the composite tissue graft 1464 to be produced. The basic function of the tissue generating bioreactor system 1400 is to provide physiologic environment (e.g. temperature of 36 to 38 degree Celsius, humidity of 50-70%, pH of 7.2-7.6) and sufficient tissue perfusion (0.1-100 ml/g tissue depending on tissue type) to allow cell engraftment, differentiation and tissue maturation. Cells can be delivered through an injector 1460 into the vascular system or through direct injection into the composite tissue graft 1464.

The tissue generating bioreactor system 1400 can include one or more force generators 1450 inside the chamber 1454 to provide mechanical stimulation to the tissue sample or organ 1464. In some embodiments, the force generator 1450 can include a pneumatic or hydraulic cylinder driven by pump 1430C and tissue connectors 1466 support the tissue sample or organ 1464 while connecting it to the force generator. In some embodiments, the system can include a stationary tissue connector 1466A and moveable tissue connector 1466B coupled to the pneumatic or hydraulic cylinder. The system can also include one or more pressure sensors 1438C that allow the controller 1439 to monitor and control the mechanical stimulation action. The tissue connectors can be connected or coupled to the tissue to provide mechanical stimulation to the growing tissue and the embedded cells by moving the moveable tissue connector 1466B relative to the stationary tissue connector 1466A. In accordance with some embodiments of the invention, the force generator 1450 can include an electric motor (e.g., a rotary or linear motor) that can be coupled to one or more of the tissue connectors 1466 to apply a force on at least a portion fo the tissue sample or organ 1464 to provide stimulation. In accordance with some embodiments of the invention a mechanical drive or linkage can be used to impart complex physiological motion to at least a portion of the tissue sample or organ 1464 as part of the provided mechanical stimulation. In accordance with some embodiments of the invention, some of the components providing mechanical stimulation can be located inside the bioreactor chamber 1454 and some of the components providing mechanical stimulation can be located outside of the bioreactor chamber 1454.

The tissue generating bioreactor system 1400 can include an electrical stimulator 1458, providing electrical stimulation to the growing tissue. Electrical stimulation can be provided by applying 2 or more electrodes to various points on the tissue sample or organ 1464. In some embodiments of the invention, the level of development of the tissue sample or organ 1464 can measured by applying electrical stimulation and then measuring the force registered by pressure sensor 1438C indicating the magnitude of the contraction caused by the electrical stimulation signal.

In accordance with some aspects of the invention, the mechanical stimulation 1450 can be provided by providing an actuator inside the bioreactor chamber 1454 and providing a tube with pneumatic or hydraulic fluid through one of the ports in the chamber 1454 to a pneumatic or hydraulic actuator, such as pneumatic cylinder which causes at least one of the tissue connectors 1466 to move. Preferably, the motion should mimic the physiologic range of motion of the tissue sample or organ being generated. In some embodiments, the motion can be in the range from 1 to 10 mm, for example, 2 mm, 3 mm, 4 mm, 5 mm, 6 mm, 7 mm, 8 mm, 9 mm. In addition, more than one moving tissue connector 1466 can be provided depending on the tissue sample or organ 1464 (e.g., one for each finger of a hand or degree of motion of a joint). Preferably, the frequency of the motion is in the range from 0.1 Hz to 5.0 Hz and this parameter may vary as a function of the type of tissue and nature of the organ.

In accordance with some aspects of the invention, the electrical stimulation 1458 can be coordinated with the mechanical stimulation 1450 to optimize tissue generation, for example, using a computer program in the controller 1439 to control and coordinate both functions. For example, the electrical stimulation causing the cells to contract can be coordinated to correspond to the mode where the mechanical stimulation is causing the tissue sample or organ 1464 to contract or is about to complete a contraction portion of the mechanical cycle. In order to avoid potential damage to the tissue, electrical stimulation causing contraction should be avoided when mechanical stimulation is moving to produce expansion. In some embodiments of the invention, the electrical signal can include a 10-200 ms pulse square wave signal in the 0.25 to 3.0 Hz frequency range and 25-55 volt range.

In accordance with some embodiments of the invention, the recellularization system 1400 can be used to perform the recellularization process according to the invention. In accordance with some embodiments, a tissue sample or organ matrix or scaffold 1464 having at least one cannulated artery (“a”) and at least one cannulated vein (“v”) can be mounted inside the bioreactor chamber 1454 and connected to the inflow tube 1436A and outflow tube 1436B. Optionally, the chamber can be filled with cell growth media to partially or full submerge the tissue sample or organ scaffold 1464. In accordance with some embodiments, the control system 1439 can execute one or more programs on a computer to initiate the flow of cell growth media into the tissue sample or organ scaffold 1464. During this process the pumps 1430 can be initialized and ramped up while at the same time the temperature and/or pressure from the temperature and pressure sensors can be monitored. In accordance with some embodiments of the invention, the temperature can be maintained between 36 and 38 degrees C. and the pressure can be maintained between 40 mm and 70 mm of Hg. In accordance with some embodiments of the invention, the perfusion pressure can ramp up from less than 10 mm of Hg to as high as 70 mm of Hg over a predefined time period, for example, 12 hours. After a predetermined time and/or based upon sensor readings, the process can be stopped and the recellularized tissue sample or organ 1464 can be removed from the bioreactor chamber 1454.

In accordance with some embodiments of the invention, the tissue generating bioreactor system 1400 can operate using a pressure controlled perfusion mode in which the pressure of the inflowing recellularization media is maintained at a predefined pressure or follows a predefined pressure profile by reading pressure sensors and modulating the inflow pump 1430A to achieve the desired pressure. This embodiment is in contrast to other embodiments where the inflow is controlled based on a desired volumetric flow rate of perfusion. In the pressure controlled perfusion mode, the system can be figured to provide a minimum predefined pressure or maximum (not to exceed) predefined pressure. The speed of the inflow pump 1430A can be controlled as function of the inflow pressure measured by pressure sensor 1438A.

In accordance with some embodiments of the invention, the reaction chamber 1454 can be operated to maintain either a neutral pressure, a positive pressure or a negative pressure environment. The pressure inside the reaction chamber 1454 can be equalized using a filter 1457 in order to release any pressure that might build up in the reaction chamber 1454, thus providing a neutral pressure cell culture environment. The pressure of the system can be measured by a pressure sensor 1438C mounted inside the heating chamber 1455 or an external pressure sensor attached to a port on the chamber wall. The filter 1457 can include a valve to allow the filter to be closed so that the pressure inside the reaction chamber 1454 can be modified by changing the relative pressures of the flow through the inflow tube 1436A and the flow through one or more outflow tube 1436B. In accordance with some embodiments, the pressure inside the reaction chamber can change over time and be changed by the control system according to a predefined pressure profile which identifies specific pressures or pressure ranges over the course of time.

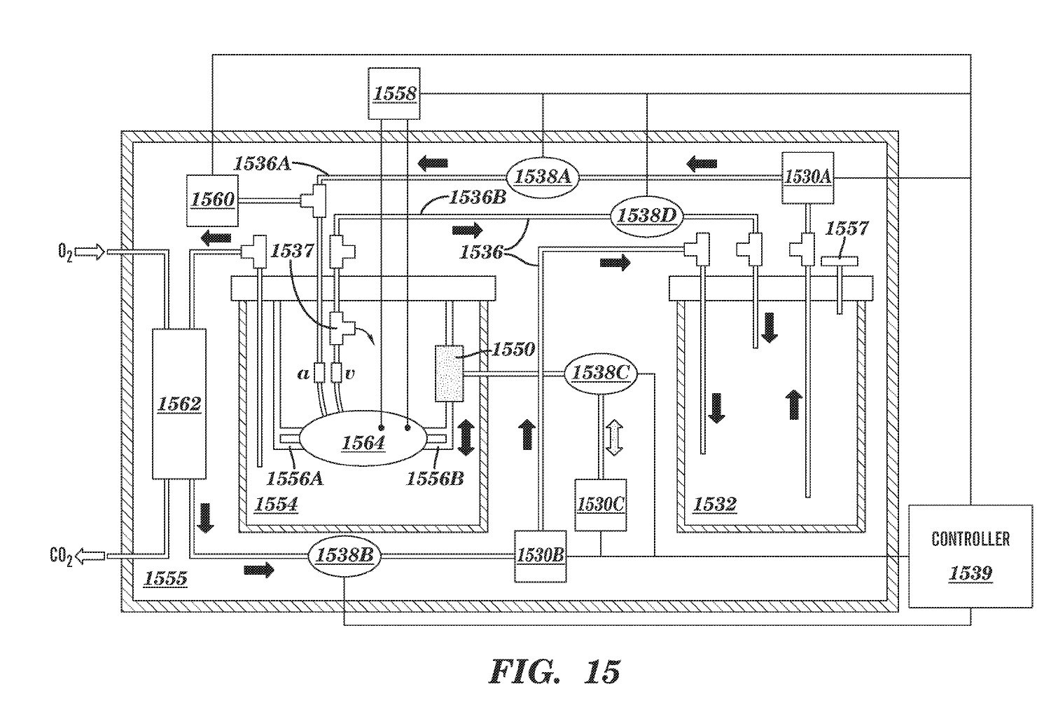

FIG. 15 shows a schematic view of a tissue generating bioreactor system 1500 according to another embodiment of the invention. The recellularization or tissue generation process according to the invention can be performed using a tissue generating bioreactor system such as bioreactor system 1500 to convert a tissue scaffold into a composite tissue graft 1564. The bioreactor system 1500 can include, a bioreactor chamber 1554, a heating chamber 1555, a media reservoir 1532, one or more fluid pumps 1530, tubing 1536 for transporting perfusion media, one or more pressure sensors 1538, one or more temperature sensors (not shown), one or more pH sensors (not shown), one or more force generators 1550, one or more electrical stimulation devices 1558, one or more injectors 1560, one or more gas exchangers 1562, and a control system 1539, such as a computer 244 connected to the operative components to control at least some aspects of the recellularization process. In accordance with some embodiments of the invention the control system can include a computer 244 having one or more processors and one or more associated memories. The control system can also include a hardware interface 246 connected to computer 244 to provide an interface between the controlled devices (e.g., fluid pumps 1530) and sensors (e.g. pressure sensors 1538, temperature sensors, and pH sensors) and the computer 244. In addition, the control system can also include a computer screen 242 for displaying information relating to the process, such as sensor reading and pump status (e.g. on/off and speed) to permit monitoring of the process and one or more data storage devices 248 for storing process data and documentation.

In accordance with some embodiments of the invention, the bioreactor chamber 1554 can be a sterile chamber with one or more ports that allow one or more tubes to be inserted into the bioreactor chamber 1554 to allow recellularization perfusion media to flow into and out of the chamber as well as to monitor and control the pressure and/or temperature within the bioreactor chamber 1554. The chamber 1554 can include an opening and a mount (e.g., one or more tissue connectors 1566) to allow tissue samples or organs to be inserted and supported within the chamber 1554. In addition, the chamber 1554 can include one or more ports to allow one or more tubes 1536 to pass through one or more walls of the chamber 1554. In some embodiments of the invention, the tubes 1536 can transport recellularization media to the tissue sample or organ 1564 as part of the recellularization process. The tissue sample or organ scaffold 1564 can include one or more cannulated arteries (“a”) and one or more cannulated veins (“v”) to enable recellularization media to enter and leave the tissue sample or organ 1564. As shown in FIG. 15, the arterial cannulas can be connected to the inflow tube 1536A and the venous cannulas can be connected to the outflow tube 1536B.

In accordance with some embodiments of the invention, a cell injector 1560 can be connected to one of the inflow tubes 1536A to allow cells to be injected into one or more of the cannulated arteries during the recellularization process. The cell injector 1560 can be connected to and controlled by computer 244 to deliver a known volume of cell suspension over a defined period of time (such as 1 million per 10 ul media for a total of 1 cc over 1 minute). The cell injector 1560 can also be connected to one or more needles that can be inserted directly into the tissue and attached to the cell injector via tubing. The cell injector 1560 can also draw from a suspension reservoir that can be periodically or continuously agitated to keep the cells in suspension (such as a magnetic stir plate).

In this embodiment of the invention, an inflow pump 1530A draws fluid recellularization media from the media reservoir 1532 and pumps the recellularization media through the inflow tube 1536A into the arterial cannula (“a”) of the tissue sample or organ 1564. In addition, an outflow pump 1530B draws recellularization media from the bottom of chamber 1554 through gas exchanger 1562 and pumps the newly oxygenated recellularization media into the media reservoir 1532. The gas exchanger 1562 can allow the recellularization media to be replenished, for example, by allowing oxygen to be absorbed into the recellularization media and carbon dioxide to be released from the recellularization media. The inflow tube 1536A can include one or more pressure sensors 1538A (and optionally, one or more temperature sensors, not shown) to monitor the pressure (and temperature) of the fluid entering the bioreactor chamber 1554. In some embodiments of the invention, the recellularization media can perfuse through the tissue sample or organ 1564 and collect inside the bioreactor chamber 1554. The outflow tube 1536B can be connected to the venous cannula (“v”) to direct the flow of recellularization media out of the chamber 1554 and back into the media reservoir 1532. The outflow tube 1536B can include a valve 1537 that allows some or all of the recellularization media flowing from the venous cannula (“v”) to flow back into the chamber 1554. When the valve 1537 is closed, the recellularization media flows back into the media reservoir 1532. In operation, the valve 1537 can be adjusted between open and closed to control the amount recellularization fluid that flows back into the media reservoir 1532 and the amount that flows into the chamber 1554.

In accordance with some embodiments of the invention, a sensor system can be provided to aid in determining when the recellularization process is completed. In some embodiments, an illumination system can be used to detect the level of recellularization based on transmitted or reflected electromagnetic radiation (e.g., visible light, infrared or ultraviolet radiation) of tissue sample or organ 1564. In other embodiments, an electronic system can be used to detect the level of decellularization based on the electrical properties of the tissue sample or organ 1564.

The size and complexity of the tissue generating bioreactor system 1500 can vary depending on the complexity of the composite tissue graft 1564 to be produced. The basic function of the tissue generating bioreactor system 1500 is to provide physiologic environment (e.g. temperature of 36 to 38 degree Celsius, humidity of 50-70%, pH of 7.2-7.6) and sufficient tissue perfusion (0.1-100 ml/g tissue depending on tissue type) to allow cell engraftment, differentiation and tissue maturation. Cells can be delivered through an injector 1560 into the vascular system or through direct injection into the composite tissue graft 1564.

The tissue generating bioreactor system 1500 can include one or more force generators 1550 inside the chamber 1554 to provide mechanical stimulation to the tissue sample or organ 1564. In some embodiments, the force generator 1550 can include a pneumatic or hydraulic cylinder driven by pump 1530C and tissue connectors 1566 support the tissue sample or organ 1564 while connecting it to the force generator. In some embodiments, the system can include a stationary tissue connector 1566A and moveable tissue connector 1566B coupled to the pneumatic or hydraulic cylinder. The system can also include one or more pressure sensors 1538C that allow the controller 1539 to monitor and control the mechanical stimulation action. The tissue connectors can be connected or coupled to the tissue to provide mechanical stimulation to the growing tissue and the embedded cells by moving the moveable tissue connector 1566B relative to the stationary tissue connector 1566A. In accordance with some embodiments of the invention, the force generator 1550 can include an electric motor (e.g., a rotary or linear motor) that can be coupled to one or more of the tissue connectors 1566 to apply a force on at least a portion fo the tissue sample or organ 1564 to provide stimulation. In accordance with some embodiments of the invention a mechanical drive or linkage can be used to impart complex physiological motion to at least a portion of the tissue sample or organ 1564 as part of the provided mechanical stimulation. In accordance with some embodiments of the invention, some of the components providing mechanical stimulation can be located inside the bioreactor chamber 1554 and some of the components providing mechanical stimulation can be located outside of the bioreactor chamber 1554.

The tissue generating bioreactor system 1500 can include an electrical stimulator 1558, providing electrical stimulation to the growing tissue. Electrical stimulation can be provided by applying 2 or more electrodes to various points on the tissue sample or organ 1564 and generating an alternating or continuous electrical signal (e.g., an electric potential or electric current) that is transmitted to the tissue sample or organ 1564. In some embodiments of the invention, the level of development of the tissue sample or organ 1564 can measured by applying electrical stimulation and then measuring the force registered by pressure sensor 1538C indicating the magnitude of the contraction caused by the electrical stimulation signal.

In accordance with some aspects of the invention, the mechanical stimulation 1550 can be provided by providing an actuator inside the bioreactor chamber 1554 and providing a tube with pneumatic or hydraulic fluid through one of the ports in the chamber 1554 to a pneumatic or hydraulic actuator, such as pneumatic cylinder which causes at least one of the tissue connectors 1566 to move. Preferably, the motion should mimic the physiologic range of motion of the tissue sample or organ being generated. In some embodiments, the motion can be in the range from 1 to 10 mm, for example, 2 mm, 3 mm, 4 mm, 5 mm, 6 mm, 7 mm, 8 mm, 9 mm. In addition, more than one moving tissue connector 1566 can be provided depending on the tissue sample or organ 1564 (e.g., one for each finger of a hand or degree of motion of a joint). Preferably, the frequency of the motion is in the range from 0.1 Hz to 5.0 Hz and this parameter may vary as a function of the type of tissue and nature of the organ.

In accordance with some aspects of the invention, the electrical stimulation 1558 can be coordinated with the mechanical stimulation 1550 to optimize tissue generation, for example, using a computer program in the controller 1539 to control and coordinate both functions. For example, the electrical stimulation causing the cells to contract can be coordinated to correspond to the mode where the mechanical stimulation is causing the tissue sample or organ 1564 to contract or is about to complete a contraction portion of the mechanical cycle. In order to avoid potential damage to the tissue, electrical stimulation causing contraction should be avoided when mechanical stimulation is moving to produce expansion. In some embodiments of the invention, the electrical signal can include a 10-200 ms pulse, square wave signal in the 0.25 to 3.0 Hz frequency range and 25-55 volt range.

In accordance with some embodiments of the invention, the recellularization system 1500 can be used to perform the recellularization process according to the invention. In accordance with some embodiments, a tissue sample or organ matrix or scaffold 1564 having at least one cannulated artery (“a”) and at least one cannulated vein (“v”) can be mounted inside the bioreactor chamber 1554 and connected to the inflow tube 1536A and outflow tube 1536B. Optionally, the chamber can be filled with cell growth media to partially or full submerge the tissue sample or organ scaffold 1564. In accordance with some embodiments, the control system 1539 can execute one or more programs on a computer to initiate the flow of cell growth media into the tissue sample or organ scaffold 1564. During this process the pumps 1530 can be initialized and ramped up while at the same time the temperature and/or pressure from the temperature and pressure sensors can be monitored. In accordance with some embodiments of the invention, the temperature can be maintained between 36 and 38 degrees C. and the pressure can be maintained between 40 mm and 70 mm of Hg. In accordance with some embodiments of the invention, the perfusion pressure can ramp up from less than 10 mm of Hg to as high as 70 mm of Hg over a predefined time period, for example, 12 hours. After a predetermined time and/or based upon sensor readings, the process can be stopped and the recellularized tissue sample or organ 1564 can be removed from the bioreactor chamber 1554.

In accordance with some embodiments of the invention, the tissue generating bioreactor system 1500 can operate using a pressure controlled perfusion mode in which the pressure of the inflowing recellularization media is maintained at a predefined pressure or follows a predefined pressure profile by reading pressure sensors and modulating the inflow pump 1530A to achieve the desired pressure. This embodiment is in contrast to other embodiments where the inflow is controlled based on a desired volumetric flow rate of perfusion. In the pressure controlled perfusion mode, the system can be figured to provide a minimum predefined pressure or maximum (not to exceed) predefined pressure. The speed of the inflow pump 1530A can be controlled as function of the inflow pressure measured by pressure sensor 1538A.

In accordance with some embodiments of the invention, the reaction chamber 1554 can be operated to maintain either a neutral pressure, a positive pressure or a negative pressure environment. In some embodiments, a negative pressure environment can be maintained inside the reaction chamber 1554 by operating outflow pump 1530B to draw recellularization media from the reaction chamber 1554 while maintaining a substantially sealed environment. Unlike the embodiment shown in FIG. 15, no filter is provided to allow for pressure equalization and increasing the outflow relative to the inflow can serve to reduce the pressure inside the reaction chamber 1554. The pressure inside the reaction chamber 1554 can be determined from the pressure sensors 1538A, 1538B and 1538D connected to the only tubes that passé through the chamber wall. In accordance with some embodiments, a separate pressure sensor can be connected to the inside the reaction chamber to directly monitor the pressure inside the reaction chamber 1554. Alternatively, the pressure inside the reaction chamber 1554 can be made positive by decreasing the recellularization media that is pumped out of the reaction chamber 1554 by outflow pump 1530B.

In some embodiments, the pressure in the reaction chamber can be from about −5 to about −125 mmHg. In some embodiments, the pressure in the reaction chamber can be about −10 mmHg at the time of recellularization and the negative pressure can gradually increase, e.g. over a period of at least one hour, at least two hours, at least 6 hours, at least 12 hours, or at least 24 hours.

In some embodiments, the mounts for the force generator (e.g. a stationary tissue connector 1566A and/or moveable tissue connector 1566B) can be connected to bone, muscle, or tendon.

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs. If there is an apparent discrepancy between the usage of a term in the art and its definition provided herein, the definition provided within the specification shall prevail.

For convenience, certain terms employed herein, in the specification, examples and appended claims are collected here.

The terms “decrease”, “reduced”, “reduction”, or “inhibit” are all used herein to mean a decrease by a statistically significant amount. In some embodiments, the terms “reduced”, “reduction”, “decrease”, or “inhibit” can mean a decrease by at least 10% as compared to a reference level, for example a decrease by at least about 20%, or at least about 30%, or at least about 40%, or at least about 50%, or at least about 60%, or at least about 70%, or at least about 80%, or at least about 90% or more or any decrease of at least 10% as compared to a reference level. In some embodiments, the terms can represent a 100% decrease, i.e. a non-detectable level as compared to a reference level. In the context of a marker or symptom, a “decrease” is a statistically significant decrease in such level. The decrease can be, for example, at least 10%, at least 20%, at least 30%, at least 40% or more, and is preferably down to a level accepted as within the range of normal for an individual without such disorder.

The terms “increased”, “increase”, “enhance”, or “activate” are all used herein to mean an increase by a statically significant amount. In some embodiments, the terms “increased”, “increase”, “enhance”, or “activate” can mean an increase of at least 10% as compared to a reference level, for example an increase of at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, or at least about a 2-fold, or at least about a 3-fold, or at least about a 4-fold, or at least about a 5-fold or at least about a 10-fold increase, or any increase between 2-fold and 10-fold or greater as compared to a reference level. In the context of a marker or symptom, an “increase” is a statistically significant increase in such level.

As used herein, a “subject” means a human or animal. Usually the animal is a vertebrate such as a primate, rodent, domestic animal or game animal. Primates, for example, can include chimpanzees, cynomologous monkeys, spider monkeys, and macaques, e.g., Rhesus. Rodents include, e.g., mice, rats, woodchucks, ferrets, rabbits and hamsters. Domestic and game animals include cows, horses, pigs, deer, sheep, bison, buffalo, feline species, e.g., domestic cat, canine species, e.g., dog, fox, wolf, avian species, e.g., chicken, emu, ostrich, and fish, e.g., trout, catfish and salmon. In some embodiments, the subject is a mammal, e.g., a primate, e.g., a human. The terms, “individual,” “patient” and “subject” are used interchangeably herein.

Preferably, the subject is a mammal. The mammal can be a human, non-human primate, mouse, rat, dog, cat, horse, or cow, but is not limited to these examples. Mammals other than humans can be advantageously used as subjects that represent animal models of corresponding human composite tissues. A subject can be male or female.

A subject can be one who has been previously diagnosed with or identified as suffering from or having a condition in need of treatment (e.g. a subject in need of transplantation of a composite tissue and/or biomimetic composition) or one or more complications related to such a condition, and optionally, have already undergone treatment. Alternatively, a subject can also be one who has not been previously diagnosed as having such a condition or one or more complications related to such a condition. For example, a subject can be one who exhibits one or more risk factors for a condition or one or more complications related to a condition or a subject who does not exhibit risk factors.

A “subject in need” of treatment for a particular condition can be a subject having that condition, diagnosed as having that condition, or at risk of developing that condition.

As used herein, the terms “treat,” “treatment,” “treating,” or “amelioration” refer to therapeutic treatments, wherein the object is to reverse, alleviate, ameliorate, inhibit, slow down or stop the progression or severity of a condition associated with a disease or disorder. The term “treating” includes reducing or alleviating at least one adverse effect or symptom of a condition, disease or disorder associated with a condition. Treatment is generally “effective” if one or more symptoms or clinical markers are reduced. Alternatively, treatment is “effective” if the progression of a disease is reduced or halted. That is, “treatment” includes not just the improvement of symptoms or markers, but also a cessation of, or at least slowing of, progress or worsening of symptoms compared to what would be expected in the absence of treatment. Beneficial or desired clinical results include, but are not limited to, alleviation of one or more symptom(s), diminishment of extent of disease, stabilized (i.e., not worsening) state of disease, delay or slowing of disease progression, amelioration or palliation of the disease state, remission (whether partial or total), and/or decreased mortality, whether detectable or undetectable. The term “treatment” of a disease also includes providing relief from the symptoms or side-effects of the disease (including palliative treatment). “Treatment” also encompasses function or aesthetic replacement of a damaged or defective composite tissue.

As used herein, the term “pharmaceutical composition” refers to the active agent in combination with a pharmaceutically acceptable carrier e.g. a carrier commonly used in the pharmaceutical industry. The phrase “pharmaceutically acceptable” is employed herein to refer to those compounds, materials, compositions, and/or dosage forms which are, within the scope of sound medical judgment, suitable for use in contact with the tissues of human beings and animals without excessive toxicity, irritation, allergic response, or other problem or complication, commensurate with a reasonable benefit/risk ratio. A “pharmaceutical composition” as described herein can also encompass a biomimetic or recellularized composite tissue composition, as described herein, in a preparation suitable for delivery as a transplant.

As used herein, the term “administering,” refers to the placement of a composition as disclosed herein into or onto a subject by a method or route which results in at least partial integration of the composition to the subject's circulatory, nervous, and/or metabolic systems. Pharmaceutical compositions comprising the compositions disclosed herein can be administered by any appropriate route which results in an effective treatment in the subject.

As used herein, the term “differentiation” or “differentiated” refers to cells that are more specialized in their fate or function than at a previous point in their development, and includes both cells that are terminally differentiated and cells that, although not terminally differentiated, are more specialized than at a previous point in their development. The development of a cell from an uncommitted cell (for example, a stem cell), to a cell with an increasing degree of commitment to a particular differentiated cell type, and finally to a terminally differentiated cell is known as progressive differentiation or progressive commitment. “Differentiated” is a relative term. A “differentiated cell” is a cell that has progressed further down the developmental pathway than the cell it is being compared with. Thus, stem cells can differentiate to lineage-restricted precursor cells (such as a mesodermal stem cell), which in turn can differentiate into other types of precursor cells further down the pathway (such as a cardiomyocyte precursor or a myoblast), and then to a terminally differentiated cell, which plays a characteristic role in a certain tissue type, and may or may not retain the capacity to proliferate further.

As used herein, the term “stem cell” refers to a cell in an undifferentiated or partially differentiated state that has the property of self-renewal and has the developmental potential to naturally differentiate into a more differentiated cell type, without a specific implied meaning regarding developmental potential (i.e., totipotent, pluripotent, multipotent, etc.). By self-renewal is meant that a stem cell is capable of proliferation and giving rise to more such stem cells, while maintaining its developmental potential. Accordingly, the term “stem cell” refers to any subset of cells that have the developmental potential, under particular circumstances, to differentiate to a more specialized or differentiated phenotype, and which retain the capacity, under certain circumstances, to proliferate without substantially differentiating. A stem cell is capable of proliferation and giving rise to more such stem cells while maintaining its developmental potential. In theory, self-renewal can occur by either of two major mechanisms. Stem cells can divide asymmetrically, which is known as obligatory asymmetrical differentiation, with one daughter cell retaining the developmental potential of the parent stem cell and the other daughter cell expressing some distinct other specific function, phenotype and/or developmental potential from the parent cell. The daughter cells themselves can be induced to proliferate and produce progeny that subsequently differentiate into one or more mature cell types, while also retaining one or more cells with parental developmental potential. A differentiated cell may derive from a multipotent cell, which itself is derived from a multipotent cell, and so on. While each of these multipotent cells may be considered stem cells, the range of cell types each such stem cell can give rise to, i.e., their “developmental potential,” can vary considerably. Alternatively, some of the stem cells in a population can divide symmetrically into two stem cells, known as stochastic differentiation, thus maintaining some stem cells in the population as a whole, while other cells in the population give rise to differentiated progeny only. Accordingly, the term “stem cell” refers to any subset of cells that have the developmental potential, under particular circumstances, to differentiate to a more specialized or differentiated phenotype, and which retain the capacity, under certain circumstances, to proliferate without substantially differentiating. In some embodiments, the term stem cell refers generally to a naturally occurring parent cell whose descendants (progeny cells) specialize, often in different directions, by differentiation, e.g., by acquiring completely individual characters, as occurs in progressive diversification of embryonic cells and tissues. Some differentiated cells also have the capacity to give rise to cells of greater developmental potential. Such capacity may be natural or may be induced artificially upon treatment with various factors. Cells that begin as stem cells might proceed toward a differentiated phenotype, but then can be induced to “reverse” and re-express the stem cell phenotype, a term often referred to as “dedifferentiation” or “reprogramming” or “retrodifferentiation” by persons of ordinary skill in the art.

In some embodiments, the stem or progenitor cells are pluripotent stem cells. In some embodiments, the stem or progenitor cells are totipotent stem cells. In some embodiments, a stem cell can be a somatic stem cell. The term “somatic stem cell” is used herein to refer to any stem cell derived from non-embryonic tissue, including fetal, juvenile, and adult tissue. Natural somatic stem cells have been isolated from a wide variety of adult tissues including blood, bone marrow, brain, olfactory epithelium, skin, pancreas, skeletal muscle, and cardiac muscle. Exemplary naturally occurring somatic stem cells include, but are not limited to, mesenchymal stem cells and hematopoietic stem cells.

In some embodiments, the stem or progenitor cells are adult mesenchymal stem cells. As used herein “mesenchymal stem cells” (MSCs) refers to multipotent stem cells that can be differentiated into a variety of cell types including osteoblast, chondrocytes (cartilage cells), adipocyte (fat cells), myocytes, and β-pancreatic islet cells etc. Methods of isolating and identifying mesenchymal stem cells are known in the art and can include isolating mesenchymal stem cells from adipose tissue (see U.S. Pat. No. 5,486,359 U.S. Patent Publication 2009/0148419; 2011/0171726; which are incorporated by reference herein in their entirety). Accordingly, in some embodiments, the stem or progenitor cells are adipose-derived mesenchymal stem cells. Phenotypically, MSCs express a number of markers, none of which, unfortunately, are specific to MSCs. It is generally agreed that adult human MSCs do not express the hematopoietic markers CD45, CD34, CD14, or CD11. They also do not express the costimulatory molecules CD80, CD86, or CD40 or the adhesion molecules CD31 (platelet/endothelial cell adhesion molecule [PECAM]-1), CD18 (leukocyte function-associated antigen-1 [LFA-1]), or CD56 (neuronal cell adhesion molecule-1), but they can express CD105 (SH2), CD73 (SH3/4), CD44, CD90 (Thy-1), CD71, and Stro-1 as well as the adhesion molecules CD106 (vascular cell adhesion molecule [VCAM]-1), CD166 (activated leukocyte cell adhesion molecule [ALCAM]), intercellular adhesion molecule (ICAM)-1, and CD29. In some embodiments, the presence of the markers Stro1, CD29, CD105, CD73 and CD44 and the absence of the markers CD19 and CD4 is used to identify cells as having an MSC phenotype. In contrast, hPSCs can be differentiated as lacking expression of CD73. There are several reports that describe the isolation of both human and rodent MSCs using antibody selection based on the phenotype of MSCs. Some have used a method of negative selection to enrich for MSCs, whereby cells from the hematopoietic lineage are removed; others have used antibodies to positively select for MSCs. MSCs from other species do not express all the same molecules as those on human cells; for example, although human and rat MSCs have been shown to be CD34-, some papers report variable expression of CD34 on murine MSCs. It is generally accepted that all MSCs are devoid of the hematopoietic marker CD45 and the endothelial cell marker CD31. However, it is important to note that differences in cell surface expression of many markers can be influenced by factors secreted by accessory cells in the initial passages, and the in vitro expression of some markers by MSCs does not always correlate with their expression patterns in vivo.

In some embodiments, the stem or progenitor cells are induced pluripotent stem cells (iPSCs). Stem cells can be naturally occurring cells isolated from an organism or maintained in culture or they can be induced stem cells. As used herein, “induced stem cells” refers to pluripotent stem cells which are created from differentiated cells by increasing the level or activity of certain factors known to promote dedifferentiation. For example, iPSCs can be obtained by overexpression of transcription factors such as Oct4, Sox2, c-Myc and Klf4 according to the methods described in Takahashi et al. (Cell, 126: 663-676, 2006). Other methods for producing iPSCs are described, for example, in Takahashi et al. Cell, 131: 861-872, 2007 and Nakagawa et al. Nat. Biotechnol. 26: 101-106, 2008; each of which are incorporated by reference herein in their entirety. By way of non-limiting example, fibroblasts can be dedifferentiated to form iPSCs. Fully reprogrammed iPSCs can be identified by, for example, expression of the pluripotency markers ALPL, DNMT3B, DPPA4, FGF4, FOXD3, GDF3, LEFTY1(LEFTB), LEFTY2 (EBAF), NODAL, PODXL, TGDF1, UTF1, ZFP42 and Xist and the lack of expression of, e.g., the spontaneous differentiation marker HAND1 and the somatic cell marker COLA1. Reprogramming can be performed via viral vectors, plasmid vectors, or mRNA encoding reprogramming factors, or, for example, by direct introduction of reprogramming factor proteins, according to methods well known in the art.

In one embodiment, the stem or progenitor cells are endothelial progenitor cells (EPCs). Endothelial progenitor cells are cells which are capable of mediating vasculogenic activity, including the formation of new endothelial cells and blood vessels. EPCs can be isolated, e.g. from peripheral blood or cord blood. In some embodiments, EPCs can be used to derive endothelial cells in vitro, and those endothelial cells can be used to recellularized a decellularized composite tissue scaffold. EPCs can be identified and/or isolated by methods known in the art, e.g. the “endothelial outgrowth” subset of EPCs are known to express CD146, thrombomodulin, VEGFR2, VE-cadherin, CD31, CD34, CAV1, VWF and do not express CD45 and CD14 while the eEPC subset of EPCs are known to express HLA-CRA, LYZ, CD14, CD34, CD31, VEGFR2, Tie2, E-selectin and can be isolated by the CFU-Hill assay (commercially available, e.g. Cat. No. 05900, Stem Cell Technologies; Vancouver, Calif.) (for more discussion, see, e.g. Medina et al. BMC Medical Genomics 2010 3:18; Timmermans et al. Stem Cells Reviews Series J Cell Mol Med 2009 13:87-102; and Allen et al. Stem Cells 2010 28:318-328; each of which is incorporated by reference herein in its entirety).

In one embodiment, the stem or progenitor cells are embryonic stem cells. Embryonic stem cells are totipotent and derived from tissue formed after fertilization but before the end of gestation, including pre-embryonic tissue (such as, for example, a blastocyst), embryonic tissue, or fetal tissue taken any time during gestation, typically but not necessarily before approximately 10-12 weeks gestation. Embryonic stem cells can be obtained directly from suitable tissue, including, but not limited to human tissue, or from established embryonic cell lines. In one embodiment, embryonic stem cells are obtained as described by Thomson et al. (U.S. Pat. Nos. 5,843,780 and 6,200,806; Science 282:1145, 1998; Curr. Top. Dev. Biol. 38:133 ff, 1998; Proc. Natl. Acad. Sci. U.S.A. 92:7844, 1995 which are incorporated by reference herein in their entirety).

As used herein, “progenitor cells” refers to cells in an undifferentiated or partially differentiated state and that have the developmental potential to differentiate into at least one more differentiated phenotype, without a specific implied meaning regarding developmental potential (i.e., totipotent, pluripotent, multipotent, etc.) and that does not have the property of self-renewal. Accordingly, the term “progenitor cell” refers to any subset of cells that have the developmental potential, under particular circumstances, to differentiate to a more specialized or differentiated phenotype.

As used herein, the term “somatic cell” refers to any cell other than a germ cell, a cell present in or obtained from a pre-implantation embryo, or a cell resulting from proliferation of such a cell in vitro. Stated another way, a somatic cell refers to any cell forming the body of an organism, as opposed to a germline cell.

The term “statistically significant” or “significantly” refers to statistical significance and generally means a two standard deviation (2SD) or greater difference.

Other than in the operating examples, or where otherwise indicated, all numbers expressing quantities of ingredients or reaction conditions used herein should be understood as modified in all instances by the term “about.” The term “about” when used in connection with percentages can mean±1%.

As used herein the term “comprising” or “comprises” is used in reference to compositions, methods, and respective component(s) thereof, that are essential to the method or composition, yet open to the inclusion of unspecified elements, whether essential or not.

The term “consisting of” refers to compositions, methods, and respective components thereof as described herein, which are exclusive of any element not recited in that description of the embodiment.

As used herein the term “consisting essentially of” refers to those elements required for a given embodiment. The term permits the presence of elements that do not materially affect the basic and novel or functional characteristic(s) of that embodiment.

The singular terms “a,” “an,” and the include plural referents unless context clearly indicates otherwise. Similarly, the word or is intended to include and unless the context clearly indicates otherwise. Although methods and materials similar or equivalent to those described herein can be used in the practice or testing of this disclosure, suitable methods and materials are described below. The abbreviation, “e.g.” is derived from the Latin exempli gratia, and is used herein to indicate a non-limiting example. Thus, the abbreviation “e.g.” is synonymous with the term “for example.”

Definitions of common terms in cell biology and molecular biology can be found in “The Merck Manual of Diagnosis and Therapy”, 19th Edition, published by Merck Research Laboratories, 2006 (ISBN 0-911910-19-0); Robert S. Porter et al. (eds.), and The Encyclopedia of Molecular Biology, published by Blackwell Science Ltd., 1994 (ISBN 0-632-02182-9). Definitions of common terms in molecular biology can also be found in Benjamin Lewin, Genes X, published by Jones & Bartlett Publishing, 2009 (ISBN-10: 0763766321); Kendrew et al. (eds.), Molecular Biology and Biotechnology: a Comprehensive Desk Reference, published by VCH Publishers, Inc., 1995 (ISBN 1-56081-569-8) and Current Protocols in Protein Sciences 2009, Wiley Intersciences, Coligan et al., eds.

Unless otherwise stated, the present invention was performed using standard procedures, as described, for example in Sambrook et al., Molecular Cloning: A Laboratory Manual (3 ed.), Cold Spring Harbor Laboratory Press, Cold Spring Harbor, N.Y., USA (2001); Davis et al., Basic Methods in Molecular Biology, Elsevier Science Publishing, Inc., New York, USA (1995); Current Protocols in Cell Biology (CPCB) (Juan S. Bonifacino et. al. ed., John Wiley and Sons, Inc.), and Culture of Animal Cells: A Manual of Basic Technique by R. Ian Freshney, Publisher: Wiley-Liss; 5th edition (2005), Animal Cell Culture Methods (Methods in Cell Biology, Vol. 57, Jennie P. Mather and David Barnes editors, Academic Press, 1st edition, 1998) which are all incorporated by reference herein in their entireties.

Other terms are defined herein within the description of the various aspects of the invention.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. Moreover, due to biological functional equivalency considerations, some changes can be made in protein structure without affecting the biological or chemical action in kind or amount. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The technology described herein is further illustrated by the following examples which in no way should be construed as being further limiting.

Some embodiments of the technology described herein can be defined according to any of the following numbered paragraphs:
1. A biomimetic composition comprising:
   a) a decellularized composite tissue scaffold from a first individual;
   b) viable grafted cells from a second individual;
   wherein said cells are attached to said scaffold;
   wherein said cells are arranged in said composition in a manner including one or more of:
      correct axis of cellular orientation within the composition;
      functional interface with at least one other structure in the composition; and
      three dimensional arrangement on said scaffold that corresponds to the arrangement of cells of said composite tissue prior to decellularization.
2. The composition of paragraph 1, wherein said composition comprises at least two tissue structures comprising the grafted cells.
3. The composition of any of paragraphs 1-2, wherein said composition comprises at least two tissue types comprising the grafted cells.
4. The composition of any of paragraphs 1-3, wherein the grafted cells are comprised by a tissue of a type selected from the group consisting of:
   muscle tissue; nervous tissue; bone tissue; cartilaginous tissue; dermal tissue; adipose tissue; lymphatic tissue; connective tissue; ligaments; tendons; and endothelial tissue.
5. The composition of any of paragraphs 1-4, wherein the composition comprises cells of at least two cell types.
6. The composition of any of paragraphs 1-5, wherein the grafted cells comprise cells selected from the group consisting of:
   myocytes; myoblasts; osteocytes; osteoblast; chondrocytes; chondroblasts; fibrocytes; fibroblasts; adipocytes; dermal cells; endothelial cells; and nerve cells.
7. The composition of any of paragraphs 1-6, wherein the functional interface with at least one other structure comprises a functional interface with at least one other tissue structure.
8. The composition of any of paragraphs 1-7, wherein the functional interface with at least one other structure in the composition comprises a physical connection.
9. The composition of any of paragraphs 1-8, wherein the functional interface with at least one other structure in the composition comprises an electrical connection.
10. The composition of any of paragraphs 1-9, wherein the grafted cells comprise a stem cell or the progeny thereof.
11. The composition of paragraph 11, wherein the stem cell is selected from the group consisting of:
   mesenchymal stem cell; adult stem cell; iPS cell; progenitor cell; and embryonic stem cell.
12. The composition of any of paragraphs 1-11, wherein the decellularized composite tissue scaffold is from a biological source xenogenic to the grafted cells.
13. The composition of any of paragraphs 1-12, wherein the decellularized composite tissue scaffold is derived from a limb or a portion thereof.
14. The composition of paragraph 13; wherein the decellularized scaffold is created by a method comprising:
   perfusing the composite tissue with a cellular disruption solution; and
   perfusing the composition tissue with a rinsing solution.
15. The composition of any of paragraphs 1-14, wherein the biomimetic composition is maintained by a method comprising:
   perfusing the biomimetic composition with a growth or differentiation medium.
16. The composition of paragraph 15, wherein maintaining the biomimetic composition further comprises stimulating the biomimetic composition mechanically or electrically.
17. The composition of any of paragraphs 1-16, further comprising an implant selected from the group consisting of:
   nerve graft; a vascular graft; a dermal graft; a bone graft; a bone substitute material; a dermal substitute graft; a joint substitute graft; a ligament graft; a tendon graft; a cartilage graft; and a muscle graft.
18. The composition of any of paragraphs 1-17, wherein the composition is connected to a device which provides nutrients, electrical stimulation, or mechanical stimulation.
19. The composition of any of paragraphs 1-18, wherein the composition is connected to a device of any of paragraphs 39-58.
20. A method of making a biomimetic composition, the method comprising:
   a) contacting a decellularized composite tissue obtained from a first individual with viable cells from a second individual; and
   b) maintaining the decellularized composite tissue and viable cells under conditions suitable for the growth and attachment of the cells.
21. The method of paragraph 20, wherein the viable cells or their progeny comprise at least two cell types.
22. The method of any of paragraphs 20-21, wherein the viable cells or their progeny comprise cells selected from the group consisting of:
   myocytes; myoblasts; osteocytes; osteoblast; chondrocytes; chondroblasts; fibrocytes; fibroblasts; adipocytes; dermal cells; endothelial cells; and nerve cells.
23. The method of any of paragraphs 20-22, wherein, after step b), the viable cells or their progeny are arranged in the composition in a manner including one or more of:
   correct axis of cellular orientation within the composition;
   functional interface with at least one other structure in the composition; and
   three dimensional arrangement on said scaffold that corresponds to the arrangement of cells of said composite tissue prior to decellularization.
24. The method of any of paragraphs 20-23, wherein, after step b), the viable cells or their progeny form at least two tissue structures.
25. The method of any of paragraphs 20-24, wherein, after step b), the viable cells or their progeny form at least two tissue types comprising the grafted cells.
26. The method of paragraph 25, wherein the tissue is selected from the group consisting of:
   muscle tissue; nervous tissue; bone tissue; cartilaginous tissue; dermal tissue; adipose tissue; lymphatic tissue; connective tissue; ligaments; tendons; and endothelial tissue.
27. The method of any of paragraphs 20-26, wherein the functional interface with at least one other structure comprises a functional interface with at least one other tissue structure.
28. The method of any of paragraphs 20-27, wherein the functional interface with at least one other structure in the composition comprises a physical connection.
29. The method of any of paragraphs 20-28, wherein the functional interface with at least one other structure in the composition comprises an electrical connection.
30. The method of any of paragraphs 20-29, wherein the viable cells comprise a stem cell or the progeny thereof.
31. The method of paragraph 30, wherein the stem cell is selected from the group consisting of:
   mesenchymal stem cell; adult stem cell; iPS cell; progenitor cell; and embryonic stem cell.
32. The method of any of paragraphs 20-30, wherein the decellularized composite tissue is from a biological source xenogenic to the viable cells.
33. The method of any of paragraphs 20-32, wherein the decellularized composite tissue scaffold is derived from a limb or a portion thereof.
34. The method of any of paragraphs 20-33, wherein the biomimetic composition is maintained by a method comprising:
   perfusing the biomimetic composition with a growth or differentiation medium.
35. The method of paragraph 34, wherein maintaining the biomimetic composition further comprises stimulating the biomimetic composition mechanically or electrically.
36. The method of any of paragraphs 20-35, further comprising introducing into the biomimetic composition an implant selected from the group consisting of:
   nerve graft; a vascular graft; a dermal graft; a bone graft; a bone substitute material; a dermal substitute graft; a joint substitute graft; a ligament graft; a tendon graft; a cartilage graft; and a muscle graft.
37. The method of any of paragraphs 20-36, wherein the composition is connected to a device which provides nutrients, electrical stimulation, or mechanical stimulation.
38. The method of any of paragraphs 20-37, wherein the composition is connected to a device of any of paragraphs 39-58.
39. A tissue generator system for generating cell growth within a tissue scaffold, the system comprising:
   a bioreactor chamber having at least one inflow tube adapted to be connected to an artery of the tissue scaffold and at least one outflow flow tube adapted to be connected to a vein of the tissue scaffold;
   an inflow pump connected to the inflow tube and adapted to pump perfusion media into the bioreactor chamber through the inflow tube;
   at least one further outflow tube extending into the bioreactor chamber and providing outflow of perfusion media from the bioreactor chamber; and
   a gas exchanger connected to the pump and adapted to replenish the media flowing through the gas exchanger.
40. The tissue generator system according to paragraph 39 further comprising a tissue mount for supporting the tissue scaffold and an actuator, coupled to the tissue mount, adapted to provide mechanical stimulation to the tissue scaffold.
41. The tissue generator system according to paragraph 40 wherein the actuator includes a pneumatic or hydraulic actuator connected to a pneumatic or hydraulic pump whereby the actuator imparts a motion to the tissue mount.
42. The tissue generator system according to paragraph 41 wherein the motion imparted by the actuator is at least one of rotation and translation.
43. The tissue generator system according to paragraph 40 wherein the actuator includes an electric motor connected to an electric power source whereby the actuator imparts a motion to the tissue mount.
44. The tissue generator system according to paragraph 39 further comprising at least two electrodes extending into the bioreactor chamber and adapted to apply an electrical stimulation signal to the tissue scaffold.
45. The tissue generator system according to paragraph 44 wherein the electrical stimulation signal includes a square wave having pulse width ranging from 10 ms to 200 ms and voltage ranging from 30 to 50 volts.
46. The tissue generator according to paragraph 39 further comprising a controller connected to the inflow pump and an inflow pressure sensor coupled to the inflow tube for measuring pressure of the perfusion media flowing through the inflow tube, wherein the controller controls the inflow pump as a function of the measured pressure.
47. The tissue generator according to paragraph 46 wherein the bioreactor chamber further includes a filter permitting gas flow into and out of the bioreactor chamber and providing neutral pressure inside of the bioreactor chamber.
48. The tissue generator according to paragraph 46 further comprising an outflow pump connected to the further outflow tube, the outflow pump being adapted to draw perfusion media from within the bioreactor chamber and create a negative pressure within the bioreactor chamber.
49. The tissue generator according to paragraph 48 further comprising a outflow pressure sensor coupled to the further outflow tube and wherein the controller is connected to the outflow pump and the outflow pressure sensor and controls the inflow pump and the outflow pump to maintain a negative pressure within the bioreactor chamber.
50. The tissue generator according to paragraph 48 further comprising a outflow pressure sensor coupled to the further outflow tube and wherein the controller is connected to the outflow pump and the outflow pressure sensor and controls the inflow pump and the outflow pump to maintain a positive pressure within the bioreactor chamber.
51. The tissue generator according to paragraph 48 further comprising a outflow pressure sensor coupled to the further outflow tube and wherein the controller is connected to the outflow pump and the outflow pressure sensor and controls the inflow pump and the outflow pump to change a pressure within the bioreactor chamber over time according to a predefined pressure protocol.
52. The tissue generator according to paragraph 39 further comprising a cell injector connected to the inflow tube and adapted for delivering a cell suspension into the inflow tube.
53. The tissue generator according to paragraph 39 further comprising a cell injector connected to one or more needles, each needle including at least a portion extending into a tissue scaffold within the bioreactor chamber.
54. The tissue generator according to paragraph 39 wherein the bioreactor chamber is contained within a heating chamber and the heating chamber operates to maintain the bioreactor chamber at a substantially constant temperature.
55. The tissue generator according to paragraph 49 wherein the bioreactor chamber is maintained between 36 and 38 degrees centigrade.
56. The tissue generator according to paragraph 39 further comprising a heating element connected to the inflow tube and adapted to apply heat to perfusion media flowing through the inflow tube.
57. The tissue generator according to paragraph 39 further comprising at least one supply reservoir containing perfusion media connected to the inflow tube whereby the inflow pump can pump perfusion media from the supply reservoir into the reactor chamber.
58. The tissue generator according to paragraph 39 further comprising at least one receiving reservoir connected to the outflow tube whereby perfusion media flowing through the outflow tube can be deposited into the receiving reservoir.

### EXAMPLES

### Example 1

The loss of an extremity is a disastrous injury with tremendous impact on a patient's life. Current mechanical prostheses are technically highly sophisticated, but only partially replace physiologic function and aesthetic appearance. Approximately 60 patients have undergone allogeneic hand transplantation to date worldwide. While outcomes are favorable, risks and side effects of transplantation and long-term immunosuppression pose a significant ethical dilemma. An autologous, bio-artificial graft based on native extracellular matrix and patient derived cells could be produced on demand and would not require immunosuppression after transplantation. To create such a graft, decellularized rat forearms were generated by detergent perfusion and yielded acellular scaffolds with preserved composite architecture. The scaffold was then repopulated with muscle, bone, connective tissue, and vasculature with cells of appropriate phenotypes, and the composite tissue matured in a perfusion bioreactor under mechanical and electrical stimulation in vitro. After confirmation of composite tissue formation, the resulting bio-composite grafts were transplanted in orthotopic position to confirm perfusion in vivo.

In the United States, over 1.5 million people live with limb loss (1). Amputation is a severe socioeconomic challenge for most patients, causing emotional trauma equivalent to the loss a loved one (2-4). Therapeutic options after limb loss include reconstructive surgery using autologous tissue if possible, or the use of prosthetic devices with a range from purely aesthetic prostheses to those with a focus on function (5). Although current prostheses are technically highly sophisticated devices, they only fulfill a minimum of physiologic function or offer less than satisfactory aesthetics (5). The vast majority of patients consider the option of prosthesis, but amputees who suffer from large defects such as bilateral above elbow amputations adapt poorly and are usually dependent on others for personal care and hygiene (6). As a new approach, worldwide about 60 patients have received allogeneic hand transplants since 1998(6). Hand transplantation (HTx), significantly improved the quality of life of upper limb amputees and eventually demonstrated hand function superior to that obtained with prosthetics (6-8). However, side effects and potentially life-threatening complications of long-term immunosuppression pose a significant ethical dilemma regarding this non-life saving reconstructive procedure (5, 8-10). A reduction of donor related risk factors, and elimination of long term immunosuppression would allow wider application of such reconstructive treatment options (6). Creation of an autologous, bioartificial forearm graft from patient derived cells would therefore be a valid alternative to allogeneic grafts. While cellular candidates such as muscle progenitor cells, endothelial progenitor cells, and mesenchymal stem cells could be isolated from patients, engineering of complex composite tissues has been challenging due to the lack of appropriate scaffold materials to support the engraftment of several cell phenotypes and the formation of viable and functional tissue.

As described herein, perfusion decellularization was used to render complex cadaveric organs acellular, resulting in native extracellular matrix scaffolds with intact tissue architecture that can be repopulated with cells to engineer functional tissue. These methods were applied to complex composite tissues such as limb grafts, by isolating rodent upper limbs, and perfusing these with a sequence of detergent and washing solutions via the native vascular system.

Cell viability in the biomimetic composition following perfusion as described herein was demonstrated with a TUNEL assay (data not shown). While normal tissue culture does not permit cell viability in tissues more than 200 μm thick, due the lack of oxygen and nutrient supply, the biomimetic compositions, when perfused according to the methods described herein have less than 5% apoptotic cells several mm into the tissue of the composition. This demonstrates that the in vitro perfusion is necessary and sufficient to maintain cell viability across the entire biomimetic composition diameter.

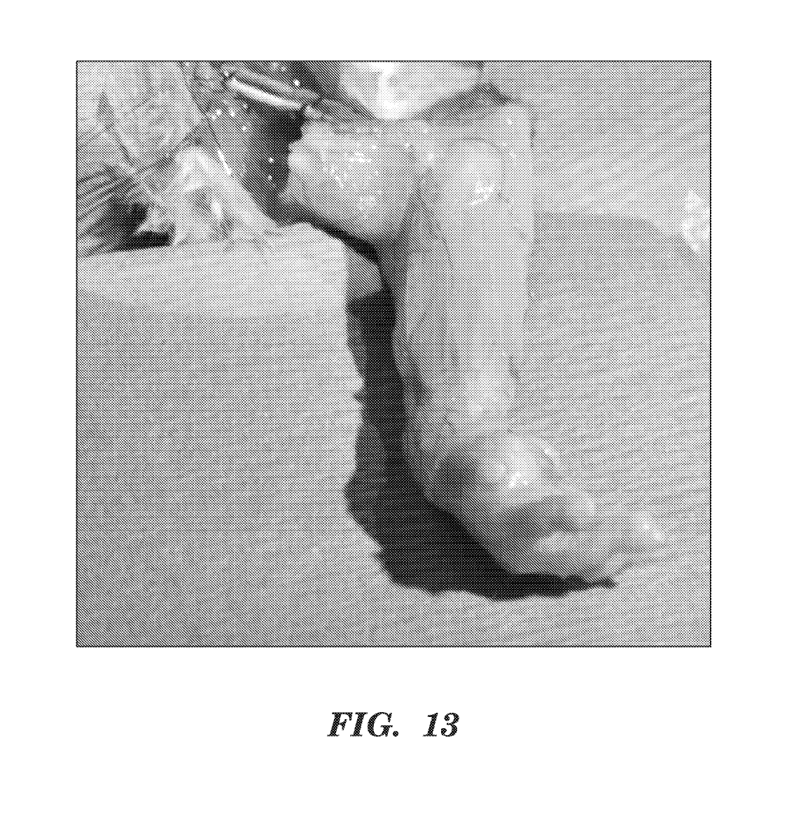

The murine forearm biomimetic composition was transplanted into a recipient in an orthotopic position. Attachment of vein, artery, and bone in the biomimetic composition to the vascular and skeletal structure of the recipient were observed and perfusion was documented (FIG. 13) (e.g. perfusion of blood vessels in the biomimetic composition with recipient blood was observed).

Materials and Methods

Perfusion Decellularization.

Male Sprague Dawley rats (Charles River Laboratories) were euthanized with 100 mg/kg ketamine (Phoenix Pharmaceutical) and 10 mg/kg xylazine (Phoenix Pharmaceutical) injected intraperitoneally. After systemic heparinization (American Pharmaceutical Partners) through the IVC, the dissection of the skin of the whole upper limb allowed us to identify the brachial artery, the brachial vein and the nerve plexus. After dissecting the upper limb from the shoulder the brachial artery was cannulated with a prefilled 25G cannula (Luer Stubs, Harvard/Instech) using a surgical microscope. Fasciotomies were performed before flushing the forearm with phosphate buffered saline (PBS). After flushing with 5 ml PBS the isolated forearm was mounted into the organ chamber and perfusion was started with 1% SDS (Sigma) for 65 h at a constant flow perfusion of 1 ml/min. This was followed by deionized water for 30 min and 1 h of perfusion with 1% Triton-X100 (Sigma). To wash out all debris, antibiotic-containing PBS (100 U/ml penicillin-G; Sigma, 0.25 mg/ml streptomycin; Sigma and amphotericin B; Sigma) was used to perfuse the forearm for 124 h.

Recellularization of Decellularized Forearms.

After washing with PBS for 124 h, decellularized rat forearms were removed from the decellularization chamber and mounted in a biomimetic stimulation bioreactor system under sterile conditions. Prior to cell seeding, the forearm matrixes were perfused with 37° C. oxygenated C2C12 growth medium for 1 h at constant flow perfusion of 5 ml/min under standard culture conditions (37° C. in 5% CO2). The biomimetic simulation bioreactor contains an organ chamber, which also serves as the main reservoir, in which the decellularized forearm is mounted. The bioreactor works as a closed-circuit system in which medium is perfused into the brachial artery by a constant flow pump (Ismatec). For cell seeding a cell mixture of 40×10⁶ C2C12 cells and 10×10⁶ mouse embryonic fibroblasts suspended in 0.5 ml of growth medium was injected via twenty injections of 30 μl each into the compartments of the decellularized forearm with a 27-G needle and a 1-cc tuberculin syringe. After cell seeding the forearm was mounted in the biomimetic stimulation bioreactor and sterile stimulation electrodes (Warner Instruments) sutured to the wrist and to the elbow of the forearm. No electrical stimulation was applied in the first 5 days. Mechanical stimulation was provided by attaching the forearm to an inflatable balloon (Harvard Apparatus) covered by a polyester mesh tube, which was connected to a small animal ventilator (Harvard Apparatus). Rate and extent of stretch could be adjusted via adjustment of the tidal volume and respiratory rate. The pressure tubing was connected to a differential pressure sensor (Harvard Apparatus), which was connected to a powerlab system, enabling triggering of electrical stimulation with mechanical stretch. The forearm was perfused with C2C12 growth media from day 0 to day 5. The medium was changed every 48 h. On day 5, the medium was switched to C2C12 differentiation medium. At day 6 electrical and mechanical stimulation was begun by applying 50-ms pulses of 20 V and 1 Hz with a Grass S48 square pulse stimulator (Grass Technologies). At day 9 the forearm matrix was seeded with 20×10⁶ HUVECs by direct infusion into the brachial artery suspended in 0.5 ml Endothelial Cell Growth media (EGM-2 Bulletkit; Lonza). After a 90-minute static period to allow for cell attachment, perfusion was restarted with a 50:50 mixture of C2C12 differentiation media and EGM-2 media. The matrix was maintained in culture for up 11 days.

C2C12 growth media comprises DMEM (Gibco) supplemented with 15% FBS, and 1% HyClone Antibiotic Antimycotic solution (Thermo Scientific). C2C12 differentiation media comprises supplemented DMEM (Gibco) with 5% horse serum (Gibco) and 1% antibiotic antimycotic solution (10,000 units/ml penicillin, 10,000 μg/ml streptomycin, and 25 μg/ml Amphotericin B; HyClone). Endothelial cell growth media (EGM-2 BULLETKIT™; Lonza) is available commercially, e.g. Cat No. CC-3162; Lonza; Basel, Switzerland).

Cell Culture.

Mouse skeletal myoblasts (C2C12) were cultured and expanded in DMEM (Gibco) supplemented with 15% FBS, and 1% HyClone Antibiotic Antimycotic solution (Thermo Scientific). Cells were cultured under standard culture conditions (37° C. in 5% CO2). Medium changed every other day. To avoid myotube formation, cells were passaged with 0.05% trypsin/EDTA (cellgro-25052C1) at 70-80% confluency. For C2C12 differentiation, we supplemented DMEM (Gibco) with 5% horse serum (Gibco) and 1% antibiotic antimycotic solution (10,000 units/ml penicillin, 10,000 μg/ml streptomycin, and 25 μg/ml Amphotericin B; HyClone).

Microtomography.

To enhance the contrast of decellularized and cadaveric muscle tissue, forearms were stained with 0.3% Phosphotungstic Acid (PTA; Sigma). For this purpose, isolated forearms were mounted in a perfusion chamber filled with 0.3% PTA dissolved in 70% ethanol and perfused via the brachial artery for 48 hours at room temperature. After staining, the specimens were scanned, mounted in 70% ethanol using a SkyScan 1173 high energy spiral scan micro-CT.

Histology.

Decellularized rat forearms were fixed, decalcified, paraffin-embedded and sectioned as follows. Decellularized rat forearms were fixed in 5% formaline overnight. After fixation, decellularized rat forearms were decalcified with 20% EDTA (Sigma), pH 7.5 for 1.5-2 weeks. The decalcification solution was changed every other day. After decalcification, rat forearms were washed for 3×30 minutes in PBS, and then transferred to 70% Ethanol. Then, decellularized rat forearms were paraffin-embedded and sectioned into 5-μm sections following standard techniques. Specimens were then stained with Masson's Trichrome (American MasterTech) and H&E (American MasterTech) stain following the manufacturer's instructions and photographed on a Nikon Eclipse 80i microscope.

Immunohistochemistry.

Specimens were fixed, decalcified, and sectioned as mentioned before. Then, paraffin sections were de-waxed and rehydrated by two changes of Formula 83 (CBG Technologies) for 5 min each, followed by a sequential alcohol gradient and rinsing in running tap water. Premade antigen retrieval solution (10 mM sodium citrate, pH 6.0) was used to do antigen retrieval. The slides were heated in antigen retrieval solution until the temperature reached 95° C. for 30 minutes. After antigen retrieval, slides were allowed to cool down to room temperature. Slides were then washed in PBS at room temperature for 5-10 minutes. After washing in PBS, slides were blocked using dual endogenous enzyme-blocking reagent (Dako) for 5 minutes. After incubating the slides in PBS for another 5 minutes, antigen blocking was performed using 4% normal goat serum (Sigma) in 1×PBS for another 30 minutes. After blocking, primary antibodies were added and incubated at 4° C. overnight. A humidified chamber was used for all incubation steps. After washing in PBS, secondary antibody was added and incubated for 30 minutes at room temperature. Slides were washed in PBS for 5 minutes prior to Diaminobezidine (DAB) development. After DAB development slides were washed in deionized water and counterstained with hematoxylin following standard protocols. After dehydration, drops of Permount Mounting Media (Fisher Scientific) were added on the slide and covered with a coverslips.

A deoxynucleotidyl TUNEL assay was used for detection of apoptotic cells following the manufacturer's instructions. In brief, the tissue sections were incubated with Proteinase K (20 μg/ml in 10 mM Tris-HCL pH 8.0) for 20 minutes at 37° C. The slides were washed 3 times in PBS for 5 minutes. After washing off the Proteinkinase K, the slides were transferred into permeabilization solution (0.1% Triton X-100 in 0.1% sodium citrate) for 2 minutes on ice. 50 μl of TUNEL reaction mixture (5 μl of TUNEL-Enzyme solution (folgt in kürze) and 45 μl TUNEL-Label solution (folgt in kürze) were added and incubated for 1 hour at 37° C. in the dark. The slides were washed 3 times in PBS for 10 minutes. Drops of Vectashield mounting media (Vector Laboratories) were added directly on top of the tissue sections and covered with a coverslip.

### REFERENCES

1. K. Ziegler-Graham, E. J. MacKenzie, P. L. Ephraim, T. G. Travison, R. Brookmeyer, Estimating the prevalence of limb loss in the United States: 2005 to 2050. Arch Phys Med Rehabil 89, 422 (March, 2008).
2. G. H. Kejlaa, The social and economic outcome after upper limb amputation. Prosthet Orthot Int 16, 25 (April, 1992).
3. M. C. Fitzpatrick, The psychologic assessment and psychosocial recovery of the patient with an amputation. Clin Orthop Relat Res, 98 (April, 1999).
4. C. M. Parkes, Reaction to the loss of a limb. Nurs Mirror Midwives J 140, 36 (Jan. 2, 1975).
5. M. Lanzetta et al., Hand transplantation: ethics, immunosuppression and indications. J Hand Surg Br 26, 511 (December, 2001).
6. S. Schneeberger et al., Achievements and challenges in composite tissue allotransplantation. Transpl Int 24, 760 (August, 2011).
7. T. Szajerka, A. Klimczak, J. Jablecki, Chimerism in hand transplantation. Ann Transplant 16, 83 (Mar. 23, 2011).
8. C. L. Kaufman, B. Blair, E. Murphy, W. B. Breidenbach, A new option for amputees: transplantation of the hand. J Rehabil Res Dev 46, 395 (2009).
9. P. Petruzzo et al., The International Registry on Hand and Composite Tissue Transplantation. Transplantation 90, 1590 (Dec. 27, 2010).
10. J. T. Shores, J. E. Imbriglia, W. P. Lee, The current state of hand transplantation. J Hand Surg Am 36, 1862 (November, 2011).
11. H. C. Ott et al., Regeneration and orthotopic transplantation of a bioartificial lung. Nat Med 16, 927 (August, 2010).
12. H. C. Ott et al., Perfusion-decellularized matrix: using nature's platform to engineer a bioartificial heart. Nat Med 14, 213 (February, 2008).

### Example 2

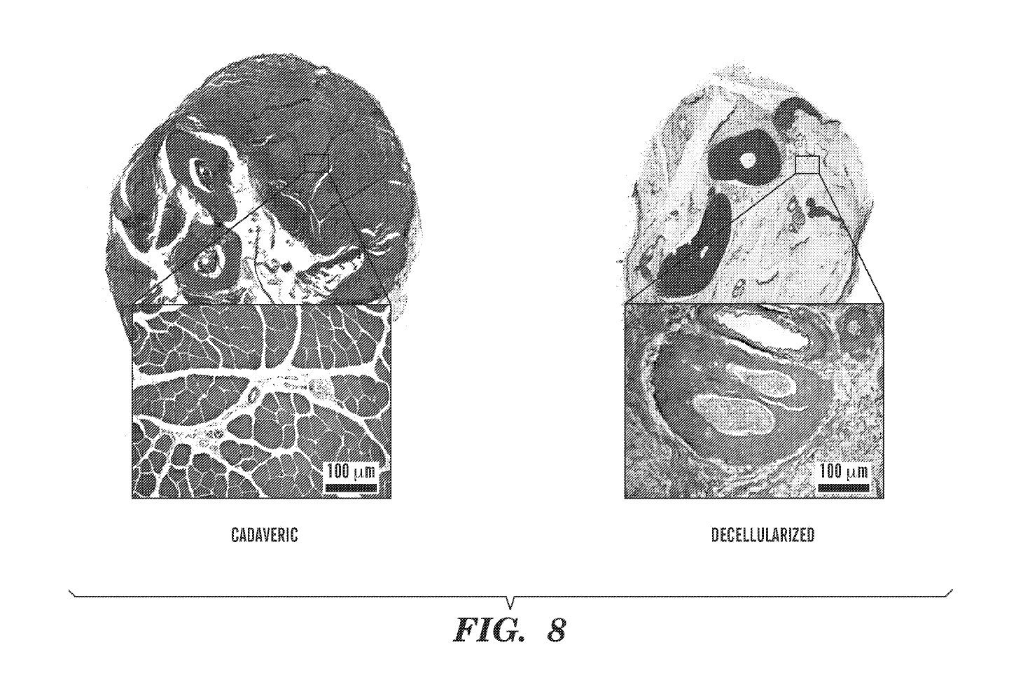

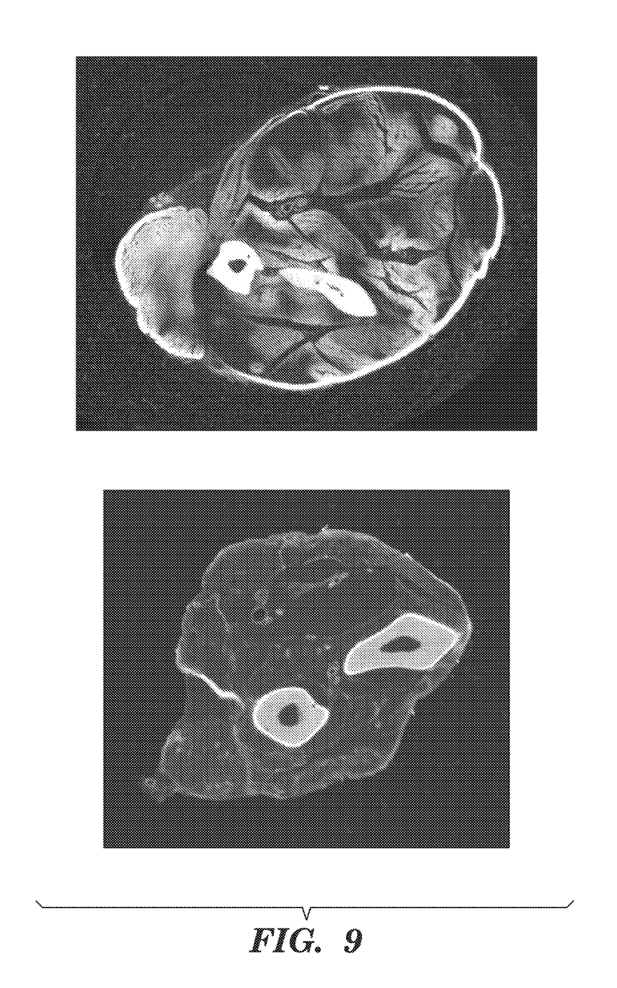

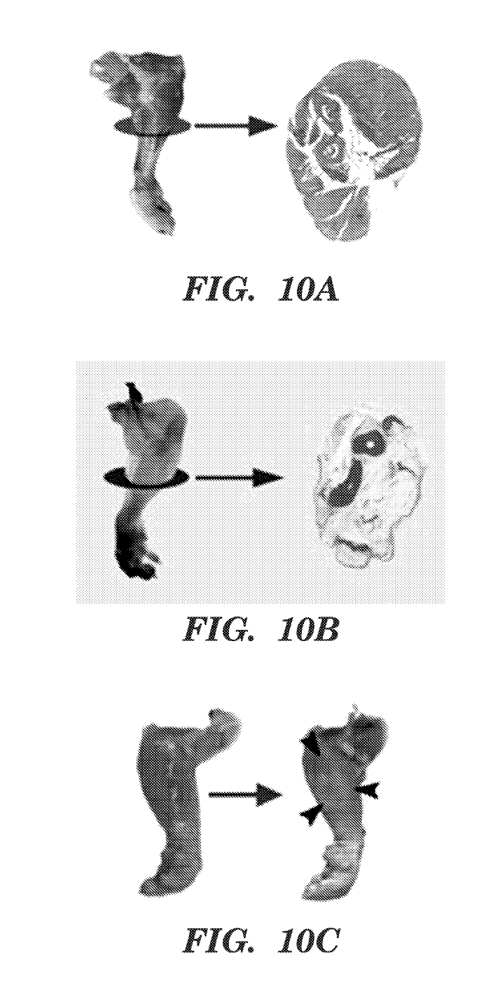

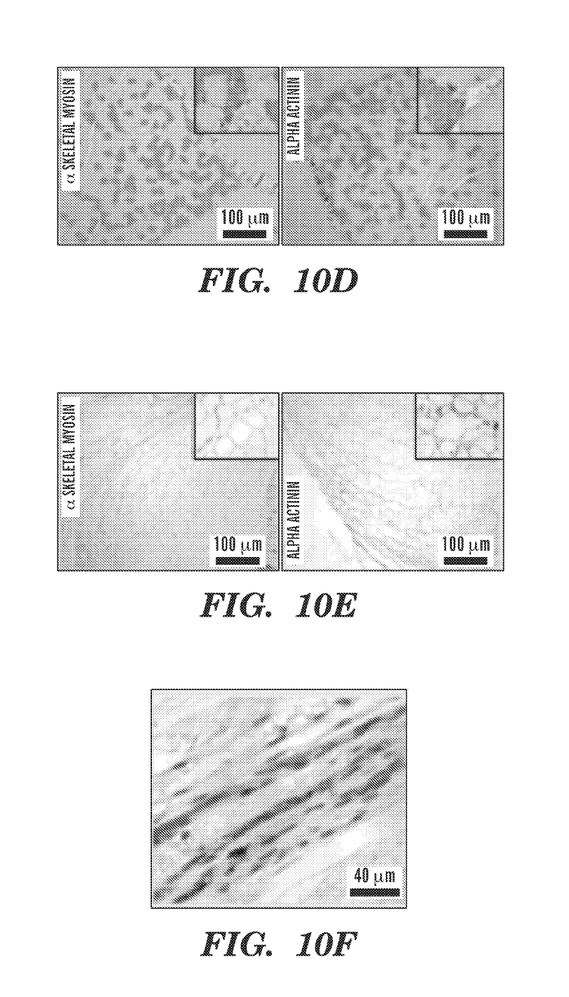

A scaffold as described herein was generated by decellularized a cadaveric forearm as shown in FIG. 5. The resulting scaffold was examined, e.g. for DNA content (FIG. 6), sGAG content (FIG. 7), by H&E staining (FIG. 8), and by microtomography (FIG. 9). The results of these analyses demonstrated that perfusion decellularization of cadaveric forearms yields an acellular 3D forearm scaffold with intact vasculature, nerval and tendinous structures.

### Example 3

Forearms were harvested from heparinized, cadaveric SD-rat donors and perfused via the brachial artery following a low concentration SDS protocol.

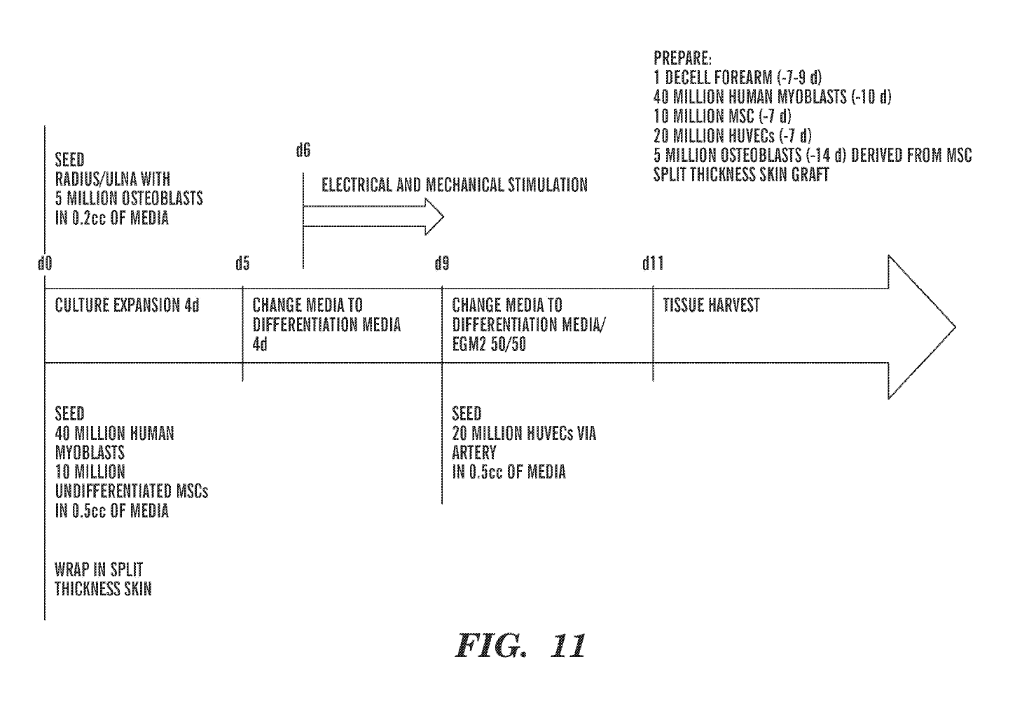

The decellularized forearm scaffolds were analyzed histologically and biochemically. Immunohistochemical staining (FIGS. 10D-10E and data not shown) revealed that the decellularized scaffolds contained no evidence of contractile elements or nuclei, in contrast to the native muscle. The DNA content of the decellularized scaffolds was analyzed and shown to be significantly decreased as compared to native muscle (347.2±274.9 ng/mg vs. 2997.9±234.3 ng/mg, P=<0.01). Analysis of sGAG content revealed that the decellularized scaffolds did not contain significantly less sGAG than native muscle (P=0.157). Histology and microtomography revealed that the decellularized scaffolds contained preserved vascular and nerval anatomy. Massons trichome staining revealed that in the scaffolds, muscle tissue and nuclei were removed, while collagen was preserved.

The decellularized forearms scaffolds were seeded with a mixture of C2C12 mouse myoblasts and mouse embryonic fibroblasts via injection. The seeded scaffolds were cultured in a constant flow bioreactor for 14 days, generated an embodiment of a biomimetic composition as described herein. Histological examination on Day 14 revealed muscle-like tissue formation on a scale similar to native muscle, as well as cell attachment. Immunohistochemical analysis showed expression of myosin heavy chain (FIG. 10F).

### Example 4

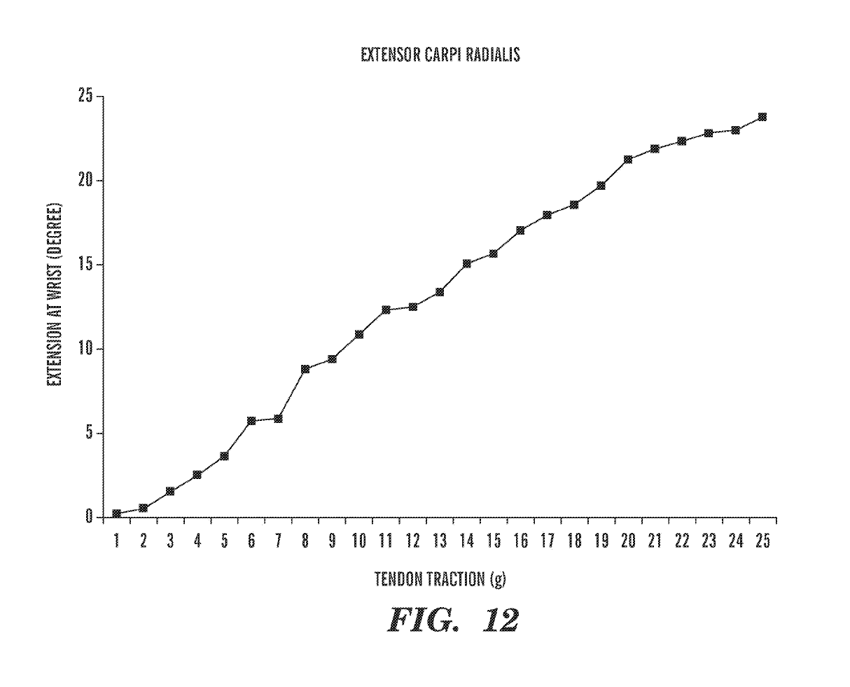

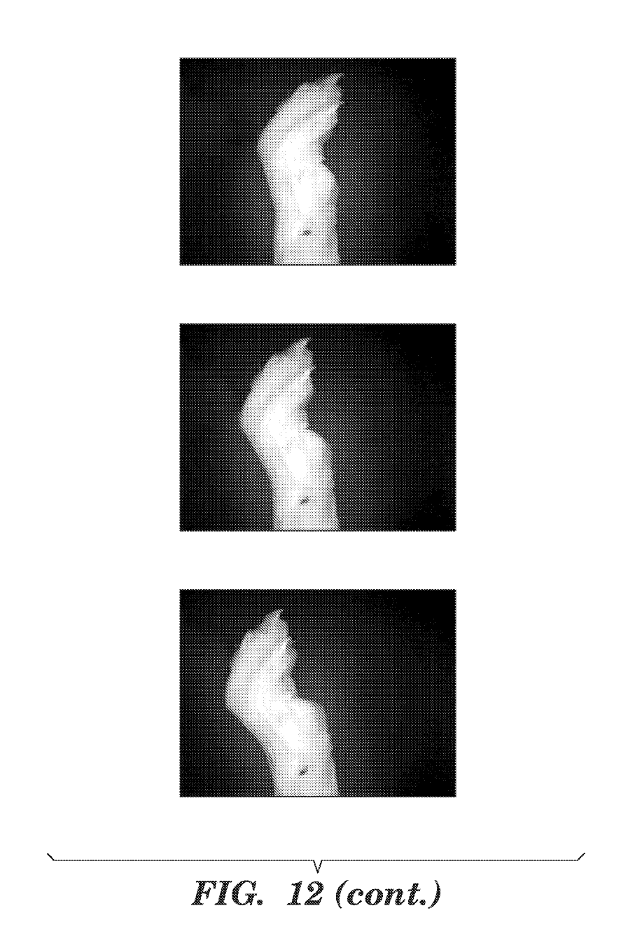

A decellularized forearm scaffold was prepared and then reseeded and maintained as shown in FIG. 11 to generate a biomimetic composition as described herein. The functionality of the engineered muscle tissues (Extensor Carpi Radialis) comprised by the biomimetic composition was then tested. Force was applied to the tendon and the resulting extension at the wrist was measured in degrees (FIG. 12). The results demonstrate that the engineered muscle tissues comprised by the biomimetic composition have functional interfaces, correct axes of orientation, and three dimensional arrangements corresponding to native tissues (e.g. functional connection to the tendon, functional connection at the distal end of the muscle, proper orientation and function of the muscle cells and fibers, etc.).

1-58. (canceled)

59. A method of making a biomimetic composition, the method comprising:
a) contacting a decellularized composite tissue obtained from a first individual with viable cells from a second individual; and
b) maintaining the decellularized composite tissue and viable cells under conditions suitable for the growth and attachment of the cells.

60. The method of claim 59, wherein the viable cells or their progeny comprise at least two cell types.

61. The method of claim 59, wherein the viable cells or their progeny comprise cells selected from the group consisting of:
myocytes; myoblasts; osteocytes; osteoblast; chondrocytes; chondroblasts; fibrocytes; fibroblasts; adipocytes; dermal cells; endothelial cells; and nerve cells.

62. The method of claim 59, wherein, after step b), the viable cells or their progeny are arranged in the composition in a manner including one or more of:
correct axis of cellular orientation within the composition;
functional interface with at least one other structure in the composition; and
three dimensional arrangement on said scaffold that corresponds to the arrangement of cells of said composite tissue prior to decellularization.

63. The method of claim 59, wherein, after step b), the viable cells or their progeny form at least two tissue structures.

64. The method of claim 59, wherein, after step b), the viable cells or their progeny form at least two tissue types comprising the grafted cells.

65. The method of claim 64, wherein the tissue is selected from the group consisting of:
muscle tissue; nervous tissue; bone tissue; cartilaginous tissue; dermal tissue; adipose tissue; lymphatic tissue; connective tissue; ligaments; tendons; and endothelial tissue.

66. The method of claim 59, wherein the functional interface with at least one other structure comprises a functional interface with at least one other tissue structure.

67. The method of claim 59, wherein the functional interface with at least one other structure in the composition comprises a physical connection.

68. The method of claim 59, wherein the functional interface with at least one other structure in the composition comprises an electrical connection.

69. The method of claim 59, wherein the viable cells comprise a stem cell or the progeny thereof.

70. The method of claim 69, wherein the stem cell is selected from the group consisting of: mesenchymal stem cell; adult stem cell; iPS cell; progenitor cell; and embryonic stem cell.

71. The method of claim 59, wherein the decellularized composite tissue is from a biological source xenogenic to the viable cells.

72. The method of claim 59, wherein the decellularized composite tissue scaffold is derived from a limb or a portion thereof.

73. The method of claim 59, wherein the biomimetic composition is maintained by a method comprising:
perfusing the biomimetic composition with a growth or differentiation medium.

74. The method of claim 73, wherein maintaining the biomimetic composition further comprises stimulating the biomimetic composition mechanically or electrically.

75. The method of claim 59, further comprising introducing into the biomimetic composition an implant selected from the group consisting of:
nerve graft; a vascular graft; a dermal graft; a bone graft; a bone substitute material; a dermal substitute graft; a joint substitute graft; a ligament graft; a tendon graft; a cartilage graft; and a muscle graft.

76. The method of claim 59, wherein the composition is connected to a device which provides nutrients, electrical stimulation, or mechanical stimulation.

77. The method of claim 59, wherein the composition is connected to a tissue generator system for generating cell growth within a tissue scaffold, the system comprising:
a bioreactor chamber having at least one inflow tube adapted to be connected to an artery of the tissue scaffold and at least one outflow flow tube adapted to be connected to a vein of the tissue scaffold;
an inflow pump connected to the inflow tube and adapted to pump perfusion media into the bioreactor chamber through the inflow tube;
at least one further outflow tube extending into the bioreactor chamber and providing outflow of perfusion media from the bioreactor chamber; and
a gas exchanger connected to the pump and adapted to replenish the media flowing through the gas exchanger.
